(19) United States
(12) Patent Application Publication
(10) Pub. No.: US 2024/0353338 A1
(43) Pub. Date: Oct. 24, 2024

(54) THERMOSTABLE RAMAN INTERACTION PROFILING (TRIP)

(71) Applicant: THE TEXAS A&M UNIVERSITY SYSTEM, College Station, TX (US)

(72) Inventors: Narangerel ALTANGEREL, College Station, TX (US); Benjamin W. NEUMAN, College Station, TX (US); Philip R. HEMMER, College Station, TX (US); Marlan O. SCULLY, College Station, TX (US); Vladislav V. YAKOVLEV, College Station, TX (US)

(21) Appl. No.: 18/634,223

(22) Filed: Apr. 12, 2024

Related U.S. Application Data
(60) Provisional application No. 63/459,296, filed on Apr. 14, 2023.

(51) Int. Cl. G01N 21/65; G01J 3/44

(52) U.S. Cl. CPC G01N 21/658; G01J 3/44

(57) ABSTRACT

The present disclosure provides methods of evaluating interactions between compositions by subjecting the interaction to Raman spectroscopy at colder temperatures. The described methods, referred to as Thermostable Raman Interaction Profiling (TRIP), provide a powerful analytical tool used for studying molecular vibrations. The methods leverage spontaneous Raman spectroscopic measurements and can be extended to other Raman spectroscopic measurements, including fast coherent anti-Stokes Raman spectroscopy (fast CARS), surface-enhanced Raman spectroscopy (SERS), stimulated Raman spectroscopy (SRS) and tip-enhanced Raman spectroscopy (TERS), to facilitate application

### CROSS-REFERENCE TO RELATED APPLICATIONS

This application claims the benefit under 35 U.S.C. § 119 (e) of U.S. Provisional Application Ser. No. 63/459,296, filed on Apr. 14, 2023, the entire disclosures of which is incorporated herein by reference.

### STATEMENT OF GOVERNMENT INTEREST

This invention was made with government support under FA9550-20-1-0366 awarded by the Air Force Office of Scientific Research, under N00014-20-1-2184 awarded by the Office of Naval Research, under W911NF-16-2-0094 awarded by the Army Research Laboratory Cooperative Agreement, under R21AI166521 awarded by DHHS-NIH-National Institute of Allergy and Infectious Diseases, and/or under 1R01GM127696, 1R21GM142107, and 1R21CA269099 awarded by the National Institutes of Health. The government has certain rights in the invention. Development of this invention was funded in part by The Welch Foundation under grant number A-1261.

### BACKGROUND AND SUMMARY

Although nucleic acids are known to carry the information of life, proteins make up nearly all of the machinery that actually keeps a cell alive. Biomolecule interactions are essential for the functioning of proteins and a better understanding of these interactions can result in important outcomes. For instance, understanding protein interactions in the human body with drugs or antibodies can predict efficacy and potentially harmful side effects in a given patient populations.

However, the study of protein interactions directly has proven to be difficult. Currently available techniques involve costly labeling of interacting partners, the degradation or destroying of proteins, and unnatural functioning of proteins in an artificial environment. Therefore, there exists a need for new systems and processes for evaluation of protein interactions.

Accordingly, the present disclosure provides methods of evaluating interactions between proteins by subjecting the interaction to Raman spectroscopy at colder temperatures. The methods, referred to as “TRIP”, have several advantages compared to the art.

For example, the methods are sensitive enough to detect interactions as small as a few hydrogen bonds and can distinguish between biologically meaningful and non-meaningful interactions. The described methods can provide repeatability of the Raman spectra over the entire data-set acquisition time, with data sets that demonstrate measurable spectral changes caused by thermal degradation not included.

TRIP is protein-friendly so that a sample can be screened many times without degradation. Cooling the temperature of the sample to the low end of its stability range allows using the highest possible laser power, thereby providing the largest possible Raman signal.

TRIP works with very small amounts of protein and also in complex aqueous solutions that resemble the inside of a cell. The signal allows working near physiologically relevant conditions and also with very small sample volumes.

Finally, TRIP is much faster than current methods and is capable of evaluating an interaction in as little as one minute. TRIP can identify the secondary structure and/or amino acid composition of proteins, as well as interactions between protein-protein and protein-ligand. Additionally, it can detect time-dependent binding events between protein-ligand pairs, including protein-protein interactions. Furthermore, TRIP measures the binding affinity between protein-ligand pairs based on alterations in their chemical bonds.

Other objects, features and advantages of the present disclosure will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTIONS OF THE DRAWINGS

The patent or application file contains at least one drawing executed in color. Copies of this patent or patent application publication with color drawings will be provided by the office upon request and payment of the necessary fee.

The detailed description particularly refers to the accompanying figures in which:

FIG. 1 shows the workflow of TRIP technique.

FIGS. 2A-2C show, in FIG. 2A, the molecular structure of the TTR (orange)-DNP (white, nitrogen molecule-blue, oxygen molecule-red) complex (PDB:2B15), with interacting Serine 117 and Alanine 108 of TTR marked in red, 2 hydrogen bonds (marked black stripe lines) between one of the DNP's nitro groups (NO₂) with Serine 117 and Alanine 108, 2 hydrogen bonds between other DNP's nitro group, and two water molecules, and 1 hydrogen bond between DNP's OH of the phenolic ring and Serine 117. FIG. 2B shows the Raman spectra of TTR, TTR-DNP mixes, and DNP (blue) with their standard errors (shaded: n_{each}=38-43). FIG. 2C shows the PCA score plots and loadings of the 800-930 cm⁻¹ and the 1230-1350 cm⁻¹ regions (In the score plots each dot represents one spectrum. In the loadings, the red numbered Raman bands changed during binding).

FIGS. 3A-3C show, in FIG. 3A, the molecular structure of the streptavidin (yellow)-biotin (green, nitrogen molecule-blue, oxygen molecule-red, sulfur molecule-yellow, double bond-light red) complex (PDB:1STP). Biotin is hydrogen bonded with streptavidin's serine 27, 45, 88, asparagine 23, aspartic acid 128 and tyrosine 43 as shown in red; interacting residues of streptavidin's Tryptophan 79, 92, 108 and 120 shown in orange. In FIG. 3B, the Raman spectra of streptavidin (green), streptavidin-biotin mix (red), and biotin (blue) are shown with their standard errors (shaded: n_{each}=35-40). FIG. 3C shows the PCA score plots and loadings of the 1^{st}, 2^{nd}, and 3^{rd} principal components of measured Raman spectra (In the score plots each dot represents one spectrum, and in the loadings the red numbered Raman bands were changed due to the binding).

FIGS. 4A-4C show, as in FIG. 4A, the protein samples of the SpA and antibody complexes. Shown in FIG. 4B is the Raman spectra of antibodies (black), their SpA mixes (blue) and SpA (pink) with their standard errors (shaded). FIG. 4C shows the PCA score plots and loadings of the first two principal components (In the score plots each dot represents one spectrum. In the loadings the red numbered Raman bands that changed due to binding).

FIGS. 5A-5C show, as in FIG. 5A, an illustration of the binding sites of RBD and the human IgG (yellow) and RBD with the mouse IgG (blue) (PDB:6SF), note that the binding sites do not overlap. FIG. 5B shows the Raman spectra of antibodies (black), their RBD mixes (blue) and RBD (red) with their standard errors (shaded). FIG. 5C shows the PCA score plots and loadings of the 1^{st}/2^{nd}/3^{rd}/4^{th} principal components of measured Raman spectra (In the score plots each dot represents one spectrum, and in the loadings, the red numbered Raman bands were changed during binding).

FIGS. 6A-6C show, as in FIG. 6A, a schematic of a Raman confocal microscope and a sketch of thermoelectric cooling device used to cool the protein solution samples on the microscope stage. FIG. 6B shows the preprocessing steps for Raman spectra of the mouse IgG, and FIG. 6C shows the processed Raman spectra of the mouse IgG from 3 different samplings (sampling 1-grey, sampling 2-light blue, and sampling 3-light green).

FIG. 7 shows the overview of the TRIP method as utilized in examples 5-10.

FIG. 8 shows the experimentally measured Raman spectra of penta-alanine (blue, averaged n>20), alanine (red, averaged n>20), and the difference spectra between the penta-alanine and the alanine curves (black).

FIGS. 9A-9C show, as in FIG. 9A, the Raman spectra of 20 amino acid (180 mM) solutions, and the constructed human insulin spectra (red) from its amino acid sequence (total of 51 AA, PDB:3140) and the Raman spectra of each of the 20 amino acids. The amino acid abbreviations are as follows: ALA—alanine, ARG—arginine, ASP—aspartic acid, ASN—asparagine, CYS—cysteine, GLN—glutamine, GLU—glutamic acid, GLY—glycine, HIS—histidine, ISO—isoleucine, LEU—leucine, LYS—lysine, MET—methionine, PHE—phenylalanine, PRO—proline, SER—serine, THE—threonine, TRP—tryptophane, TYR—tyrosine, and VAL—valine. FIG. 9B shows the measured (averaged, n>50) Raman spectrum of human insulin (blue), the combined spectrum of 51 amino acids (red), and the difference spectrum between the measured and the constructed spectra of human insulin (black). FIG. 9C shows the Human insulin structure (PDB:3140) compared in the disulfide bond region, between 500 and 550 cm⁻¹, and the amide I region, between 1620 and 1700 cm⁻¹.

FIGS. 10A-10B show, in FIG. 10A, the histograms of the amino acid frequencies of the protein samples, their molecular weights (kDa), and their total counts of amino acids. FIG. 10B shows the experimentally measured Raman spectra of the protein solutions where the averaged n>50 curves are shown in blue, their constructed spectra in red with the correlation coefficient (R2) between their constructed and measured spectra.

FIG. 11 shows the difference Raman spectra between the experimentally measured and constructed spectra where human insulin is shown in purple (PDB:3140), lysozyme in violet (PDB:1GWD), SARS CoV 2-RBD in dark blue (PDB:2GHV), protein A in magenta (PDB:2JWD), streptavidin in green (PDB:1STP), human IgG in blue, mouse IgG in red, and the subtracted spectra between mouse IgG and human IgG in grey.

FIGS. 12A-12B shows 4 consecutive Raman spectra from 1 μM M^{pro} protein solution where the 1^{st} spectrum is with cooling and 2-4 spectra without cooling, as shown in FIG. 12A. In FIG. 12B, 4 consecutive Raman spectra from 1 μM M^{pro} protein solution with cooling are shown.

FIG. 13 visually encapsulates the procedure of harnessing the TRIP technique in conjunction with MLR to estimate both the amino acid composition and secondary structures of a given protein.

FIGS. 14A-14B show, in FIG. 14A, the histograms of the actual (black) and the estimated (red with error) amino acid frequencies of SARS-CoV-2 M^{pro} (PDB:7VH8), transthyretin (PDB:2B15), and Human IgG:CR3022 (PDB:6W41, P0DOX5). FIG. 14B shows the histograms of the actual (black) and the estimated (red with error) secondary structures of the SARS-CoV-2 M^{pro} (PDB:7VH8), transthyretin (PDB:2B15), and Human IgG:CR3022 (PDB:6W41).

FIG. 15 shows overview of utilization of thermostable Raman interaction profiling (TRIP) for direct measurement of binding affinity between protein and ligand as well as between protein and protein.

FIGS. 16A-16D show, as in FIG. 16A, the relative populations of dimers (double red balls) and monomers (orange balls) in the M^{pro} solutions at 4 and 25° C., and, as based on MS measurements, a graph of the monomer and dimer dependency of M^{pro} by their concentration (monomer in orange and dimers in red). FIG. 16B shows the Raman spectra of 1 μM (blue), 5 μM (green), and 10 μM (red) M^{pro} solutions. Additionally shown is the difference spectra between the average Raman spectra of 5 μM and 1 μM (black) M^{pro} solutions, and the difference spectra between the average Raman spectra of 10 μM and 1 μM (maroon) M^{pro} solutions. The monomer is shown in light blue (PDB:7VH8) the dimer in light blue and light maroon (PDB:7CAM). FIG. 16C shows the PCA of the Raman spectra of 1 μM (blue), 5 μM (green), 10 μM (red) M^{pro} solutions.

FIG. 16D shows, on the left, the histograms of the amino acid frequencies of the SARS-CoV-2 M^{pro} 1 μM (blue), 5 μM (green), and 10 μM (red) and on the right, the histograms of the secondary structures of the SARS CoV-2 M^{pro} 1 μM (blue), 5 μM (green), and 10 μM (red).

FIGS. 17A-17D show, as in FIG. 17A, the SARS Covid M^{pro} inhibitors MPI8 (PDB:7JQ5), nirmatrelvir (PDB:8DZ2), VB-B-145, Halicin (PDB:7TUU), and their binding sites. FIG. 17B shows the Raman spectra of 1 μM M^{pro} solution (blue), 4 M inhibitors (black), the mix of MPI8 including 1 μM M^{pro} and 4 μM inhibitor (black), the Nirmatrelvir mix (orange), the VB-B145 mix (maroon), the Halicin mix (light purple), the difference spectra between average Raman spectra of the MPI8 mix and the 1 μM (black), the difference spectra between the average Raman spectra of the Nirmatrelvir mix and 1 μM (orange), the difference spectra between the average Raman spectra of the VB-B-145 mix and 1 μM (maroon), and the difference spectra between the average Raman spectra of the Halicin mix and 1 μM (light pink).

FIG. 17C shows the PCA of the Raman spectra of 1 μM (blue), MPI8 mix (black dots), Nirmatrelvir mix (orange dots), VB-B-145 mix (maroon dots), and Halicin mix (light purple dots). FIG. 17D shows the histograms of the amino acid frequencies and the secondary structures of the SARS-CoV-2 M^{pro} 1 μM (blue) mix, the MPI8 mix (black), the Nirmatrelvir mix (orange), the VB-B145 mix (maroon), the Halicin mix (light purple), and the differences between dimers including 5 μM (green), and 10 μM (red).

FIGS. 18A-18C show, in FIG. 18A, the difference Raman spectra between the Raman spectra of the protein-inhibitor mixes and the Raman spectra of M^{pro}: Mpi8 mixes (1:4-1 μM M^{pro} and 4 μM Mpi8, 5:20-5 μM M^{pro} and 20 μM Mpi8, 260:780-260 μM M^{pro} and 780 μM Mpi8) (black curves), Nirmatrelvir mixes (orange curves), Halicin mixes (light pink curves), and VB-B0145 mixes (maroon curves). FIG. 18B shows the correlations of the phenylalanine peak shift (from 1003 cm⁻¹) with increasing concentrations of M^{pro} and MPI8 (black), Nirmatrelvir (orange), Halicin (light pink), and VB-B-145 (maroon). FIG. 18C shows the enzyme inhibitions of M^{pro} where the M^{pro} activity is monitored in the presence of increasing concentrations of MPI8, Halicin, and VB-B-145.

FIG. 19 shows the overview of the synthesis of VB-B-145.

FIG. 20 shows the ¹H NMR and ¹³C NMR chemical shifts of 6-chloro-N-(isoquinolin-4-yl)-1,2,3,4-tetrahydroisoquinoline-4-carboxamide.

FIG. 21 shows the ¹H NMR and ¹³C NMR chemical shifts of 6-chloro-N-(isoquinolin-4-yl)-2-(2-(methylamino)-2-oxoethyl)-1,2,3,4-tetrahydroisoquinoline-4-carboxamide (VB-B-145).

FIG. 22 shows modeling of VB-B-145 in M^{pro} using Schrodinger Desmond MD simulation program with a 10 ns simulation time. The simulated poses of VB-B-145 were evaluated for interactions with catalytic residues, including His41 and Cys145. The simulated poses of VB-B-145 can be seen, where VB-B-145 maintains a strong dual H-bond with Glu166 via the two amides, while the a-nitrogen on the isoquinoline group forms an additional hydrogen bond with His163. Two more residues, Cys145 and Ser144 form another hydrogen bond via water bridge that contacts the same nitrogen.

FIG. 23 shows the docking of VB-B-145 in M^{pro} using Schrodinger Desmond MD simulation program with a 10 ns simulation time. As shown, during the simulation, VB-B-145 maintains a<2 Å RMSD distance from the active site, indicating consistent binding pocket compared with the co-crystalized ligand.

### DETAILED DESCRIPTION

Various embodiments of the invention are described herein as follows. As described herein, Thermostable Raman Interaction Profiling (TRIP) is a powerful analytical tool used for studying molecular vibrations. The methods leverage spontaneous Raman spectroscopic measurements and can be extended to other Raman spectroscopic measurements, including fast coherent anti-Stokes Raman spectroscopy (fast CARS), surface-enhanced Raman spectroscopy (SERS), stimulated Raman spectroscopy (SRS), and tip-enhanced Raman spectroscopy (TERS), to facilitate application. Fast coherent anti-Stokes Raman spectroscopy (fast CARS) is characterized by its rapid acquisition of Raman spectra, making it particularly suitable for time-sensitive analyses or dynamic systems. Its ability to provide real-time insights into molecular structures and interactions aligns seamlessly with the objectives of TRIP, enhancing the efficiency and scope of molecular profiling. Surface-enhanced Raman spectroscopy (SERS) enhances the Raman signals of molecules adsorbed onto metallic surfaces, enabling the detection of trace amounts of analytes with improved sensitivity.

By integrating SERS into TRIP, researchers can achieve enhanced detection limits and improved signal-to-noise ratios, thereby unlocking new possibilities for molecular characterization and detection in diverse samples. The application of stimulated Raman spectroscopy (SRS) in conjunction with TRIP methodologies offers researchers a powerful tool to probe specific molecular vibrations with exceptional resolution. Tip-enhanced Raman spectroscopy (TERS) combines Raman spectroscopy with scanning probe microscopy techniques, offering spatial resolution beyond the diffraction limit of light. This high spatial resolution enables the interrogation of individual molecules or nanoscale features with exceptional detail. Incorporating TERS into TRIP extends its capabilities to study molecular interactions and dynamics at the nanoscale, opening avenues for investigations in fields such as nanotechnology, materials science, and biophysics. In essence, the versatility of Raman spectroscopy, coupled with the enhancements provided by techniques such as fast CARS, SERS, SRS and TERS, empowers TRIP to explore a wide range of molecular phenomena with unprecedented precision, sensitivity, and spatial resolution. This synergy between TRIP and various Raman spectroscopic methods holds promise for advancing understanding of molecular systems across numerous disciplines, from fundamental research to practical applications in medicine, environmental science, and beyond.

In an illustrative aspect, a method of evaluating an interaction between a first composition and a second composition is provided. The method comprises the step of subjecting the interaction between the first composition and the second composition to Raman spectroscopy, wherein the step of subjecting is performed at a temperature between about 0° C. and about 40° C.

In an embodiment, the first composition is comprised in an aqueous composition. In an embodiment, the aqueous composition is a solution. In an embodiment, the aqueous composition is present at near physiological conditions. As used herein, near physiological conditions is generally referred to as a physiological concentration between 1 μM-10 μM (including all points in between) as present in standard physiological buffer (e.g., PBS with 7.4 pH) solutions.

In an embodiment, the first composition is a therapeutic agent. In an embodiment, the first composition is a drug. In an embodiment, the drug is a small molecule. In an embodiment, the drug is a biologic. In an embodiment, the drug is a steric inhibitor.

In an embodiment, the first composition is an antibody. In an embodiment, the first composition is an enzyme. In an embodiment, the first composition is a protein. In an embodiment, the first composition is a drug target. In an embodiment, the first composition is an antigen. In an embodiment, the first composition is a receptor. In an embodiment, the first composition is an insoluble protein. The methods described herein are capable of detecting time-dependent binding between two compositions (e.g., protein and ligand). Further, the methods described herein are capable of detecting binding affinity between two compositions (e.g., protein and ligand), for instance based on change on their chemical bonds.

In an embodiment, the second composition is comprised in an aqueous composition. In an embodiment, the aqueous composition is a solution. In an embodiment, the aqueous composition is present at near physiological conditions.

In an embodiment, the second composition is a therapeutic agent. In an embodiment, the second composition is a drug. In an embodiment, the drug is a small molecule. In an embodiment, the drug is a biologic. In an embodiment, the drug is a steric inhibitor.

In an embodiment, the second composition is an antibody. In an embodiment, the second composition is an enzyme. In an embodiment, the second composition is a protein. In an embodiment, the second composition is a drug target. In an embodiment, the second composition is an antigen. In an embodiment, the second composition is a receptor. In an embodiment, the second composition is an insoluble protein.

In an embodiment, the first composition is a drug and wherein the second composition is a drug target. In an embodiment, the first composition is an antibody and wherein the second composition is an antigen.

In an embodiment, the method is configured for multiple repetitions. In an embodiment, the method is configured for therapeutic agent screening for efficacy. In an embodiment, the method is configured for therapeutic agent screening for side effects.

In an embodiment, the method is configured for evaluating the interaction in less than 1 minute. In an embodiment, the method is configured for evaluating the interaction in less than 2 minutes. In an embodiment, the method is configured for evaluating the interaction in less than 5 minutes. In an embodiment, the method is configured for evaluating the interaction in less than 10 minutes. In an embodiment, the method is configured for evaluating the interaction in less than 30 minutes. In an embodiment, the method is configured for evaluating the interaction in less than 60 minutes.

In an embodiment, the interaction is a structural evaluation. In an embodiment, the evaluation comprises an optical measurement. In an embodiment, the optical measurement is selected from the group consisting of infrared absorption, interferometric absorption, optical absorption, scattering, fluorescence, nonlinear optical measurements, and any combination thereof. 1. The described methods are capable of using absorption of infrared radiation by molecules to discern their structural composition and chemical bonds. By incorporating infrared absorption into TRIP, complementary information can be obtained about molecular vibrations and interactions, enriching the analytical depth of the method.

The described methods are capable of using interferometric measurements, utilizing the superposition of multiple waves to extract precise information about phase differences and optical path lengths. Integrating interferometric techniques with TRIP can enhance its sensitivity and accuracy in probing molecular dynamics and intermolecular forces.

The described methods are capable of using optical absorption and scattering techniques to elucidate the interaction of light with matter, shedding light on various physical and chemical properties of materials. By leveraging these methods within TRIP, a wide range of phenomena, from nanoparticle characterization to environmental monitoring, can be explored.

The described methods are capable of using fluorescence spectroscopy, involving the emission of light by fluorophores upon excitation to provide insights into molecular structure, dynamics, and environmental changes. Incorporating fluorescence measurements into TRIP broadens its scope to include studies of biomolecular interactions, cellular processes, and environmental pollutants.

The described methods are capable of using nonlinear optical measurements to provide the nonlinear response of materials to intense light fields, thus enabling the investigation of dynamic processes and nonlinear interactions at the molecular level. By harnessing nonlinear optical methods within TRIP, phenomena such as multiphoton absorption, harmonic generation, and coherent control of molecular dynamics can be evaluated.

In an embodiment, the method further comprises a principal component analysis (PCA). In an embodiment, the method further comprises a multiple linear regression (MLR) analysis. In an embodiment, the method further comprises a principal component analysis (PCA) and a multiple linear regression (MLR) analysis.

In an embodiment, the method does not substantially degrade the first composition. In an embodiment, the degrading is heat-derived degradation. In an embodiment, the method does not substantially degrade the second composition. In an embodiment, the degrading is heat-derived degradation. For instance, heat-derived degradation can refer to laser-induced heat damage (e.g., an excitation laser).

In an embodiment, the method does not comprise labeling of the first composition. In an embodiment, the method does not comprise labeling of the second composition.

In an embodiment, the step of subjecting is performed at a temperature between about 0° C. and about 40° C. Active cooling of the sample to be evaluated is capable of measuring reputable spectra, as it can provide a thermostable sample. For example, a thermo electric coupler (TEC) unit can be utilized as an active cooler. Alternatively, other means of active cooling can be utilized, including laser cooling, liquid cooling, and air cooling.

The temperature for the described methods can be stabilized to provide a thermostable sample. A controlled and/or stabilized temperature for a given sample can provide evaluation of the sample. For instance, standard Raman microscopy/spectroscopy typically begins at room temperatures but then is rapidly heated. According to the present disclosure, the cooling of the sample prevents temperatures from rising to a level in which the protein is damaged and/or denatured and/or disintegrated.

In an embodiment, the step of subjecting is performed at a temperature between about 0° C. and about 5° C. In an embodiment, the step of subjecting is performed at a temperature between about 5° C. and about 10° C. In an embodiment, the step of subjecting is performed at a temperature between about 10° C. and about 15° C. In an embodiment, the step of subjecting is performed at a temperature between about 15° C. and about 20° C. In an embodiment, the step of subjecting is performed at a temperature between about 20° C. and about 25° C. In an embodiment, the step of subjecting is performed at a temperature between about 25° C. and about 30° C. In an embodiment, the step of subjecting is performed at a temperature between about 30° C. and about 35° C. In an embodiment, the step of subjecting is performed at a temperature between about 35° C. and about 40° C.

In an embodiment, the step of subjecting is performed at a temperature between about 3° C. and about 8° C. In an embodiment, the step of subjecting is performed at a temperature between about 8° C. and about 13° C. In an embodiment, the step of subjecting is performed at a temperature between about 13° C. and about 18° C. In an embodiment, the step of subjecting is performed at a temperature between about 18° C. and about 23° C. In an embodiment, the step of subjecting is performed at a temperature between about 23° C. and about 28° C. In an embodiment, the step of subjecting is performed at a temperature between about 28° C. and about 33° C. In an embodiment, the step of subjecting is performed at a temperature between about 33° C. and about 38° C.

In an embodiment, the step of subjecting is performed at a temperature below 5° C. In an embodiment, the step of subjecting is performed at a temperature below 10° C. In an embodiment, the step of subjecting is performed at a temperature below 15° C. In an embodiment, the step of subjecting is performed at a temperature below 20° C. In an embodiment, the step of subjecting is performed at a temperature below 25° C. In an embodiment, the step of subjecting is performed at a temperature below 30° C. In an embodiment, the step of subjecting is performed at a temperature below 35° C. In an embodiment, the step of subjecting is performed at a temperature below 40° C.

In an illustrative aspect, a method of evaluating an interaction between a first biomolecule and a second biomolecule is provided. The method comprises the step of subjecting the interaction between the first biomolecule and the second biomolecule to Raman spectroscopy, wherein the step of subjecting is performed at a temperature between about 0° C. and about 40° C.

In an embodiment, the first biomolecule is selected from the group consisting of a protein, a peptide, an amino acid, a nucleic acid, a synthetic analog of a nucleic acid, a sugar, a carbohydrate, and a lipid. In an embodiment, the second biomolecule is selected from the group consisting of a protein, a peptide, an amino acid, a nucleic acid, a synthetic analog of a nucleic acid, a sugar, a carbohydrate, and a lipid.

In an embodiment, the first biomolecule is comprised in an aqueous composition. In an embodiment, the aqueous composition is a solution. In an embodiment, the aqueous composition is present at near physiological conditions.

In an embodiment, the second biomolecule is comprised in an aqueous composition. In an embodiment, the aqueous composition is a solution. In an embodiment, the aqueous composition is present at near physiological conditions.

In an embodiment, the method is configured for multiple repetitions. In an embodiment, the method is configured for therapeutic agent screening for efficacy. In an embodiment, the method is configured for therapeutic agent screening for side effects.

In an embodiment, the method is configured for evaluating the interaction in less than 1 minute. In an embodiment, the method is configured for evaluating the interaction in less than 2 minutes. In an embodiment, the method is configured for evaluating the interaction in less than 5 minutes. In an embodiment, the method is configured for evaluating the interaction in less than 10 minutes. In an embodiment, the method is configured for evaluating the interaction in less than 30 minutes. In an embodiment, the method is configured for evaluating the interaction in less than 60 minutes.

In an embodiment, the interaction is a structural evaluation. In an embodiment, the evaluation comprises an optical measurement. In an embodiment, the optical measurement is selected from the group consisting of infrared absorption, interferometric absorption, optical absorption, scattering, fluorescence, nonlinear optical measurements, and any combination thereof.

In an embodiment, the method further comprises a principal component analysis (PCA). In an embodiment, the method further comprises a multiple linear regression (MLR) analysis. In an embodiment, the method further comprises a principal component analysis (PCA) and a multiple linear regression (MLR) analysis.

In an embodiment, the method does not substantially degrade the first biomolecule. In an embodiment, the degrading is heat-derived degradation.

In an embodiment, the method does not substantially degrade the second biomolecule. In an embodiment, the degrading is heat-derived degradation.

In an embodiment, the method does not comprise labeling of the first biomolecule. In an embodiment, the method does not comprise labeling of the second biomolecule. In an embodiment, the step of subjecting is performed at a temperature between about 0° C. and about 40° C. In an embodiment, the step of subjecting is performed at a temperature between about 0° C. and about 5° C. In an embodiment, the step of subjecting is performed at a temperature between about 5° C. and about 10° C. In an embodiment, the step of subjecting is performed at a temperature between about 10° C. and about 15° C. In an embodiment, the step of subjecting is performed at a temperature between about 15° C. and about 20° C. In an embodiment, the step of subjecting is performed at a temperature between about 20° C. and about 25° C. In an embodiment, the step of subjecting is performed at a temperature between about 25° C. and about 30° C. In an embodiment, the step of subjecting is performed at a temperature between about 30° C. and about 35° C. In an embodiment, the step of subjecting is performed at a temperature between about 35° C. and about 40° C.

In an embodiment, the step of subjecting is performed at a temperature between about 3° C. and about 8° C. In an embodiment, the step of subjecting is performed at a temperature between about 8° C. and about 13° C. In an embodiment, the step of subjecting is performed at a temperature between about 13° C. and about 18° C. In an embodiment, the step of subjecting is performed at a temperature between about 18° C. and about 23° C. In an embodiment, the step of subjecting is performed at a temperature between about 23° C. and about 28° C. In an embodiment, the step of subjecting is performed at a temperature between about 28° C. and about 33° C. In an embodiment, the step of subjecting is performed at a temperature between about 33° C. and about 38° C.

In an embodiment, the step of subjecting is performed at a temperature below 5° C. In an embodiment, the step of subjecting is performed at a temperature below 10° C. In an embodiment, the step of subjecting is performed at a temperature below 15° C. In an embodiment, the step of subjecting is performed at a temperature below 20° C. In an embodiment, the step of subjecting is performed at a temperature below 25° C. In an embodiment, the step of subjecting is performed at a temperature below 30° C. In an embodiment, the step of subjecting is performed at a temperature below 35° C. In an embodiment, the step of subjecting is performed at a temperature below 40° C.

In an illustrative aspect, a method of analyzing a biomolecule is provided. The method comprises the step of subjecting the biomolecule to Raman spectroscopy, wherein the step of subjecting is performed at a temperature between about 0° C. and about 40° C.

In an embodiment, the biomolecule is selected from the group consisting of a protein, a peptide, an amino acid, a nucleic acid, a synthetic analog of a nucleic acid, a sugar, a carbohydrate, and a lipid.

In an embodiment, the biomolecule is a protein. In an embodiment, the analyzing provides evaluation of the protein. In an embodiment, the evaluation comprises identification of a plurality of amino acids of the protein. In an embodiment, the evaluation comprises quantification of the plurality of amino acids of the protein. In an embodiment, the evaluation comprises identification of a secondary structure of the plurality of amino acids.

In an embodiment, the evaluation comprises identification of a primary structure of the protein. In an embodiment, the evaluation comprises identification of a secondary structure of the protein. In an embodiment, the evaluation comprises identification of a tertiary structure of the protein. In an embodiment, the evaluation comprises identification of a quaternary structure of the protein. In an embodiment, the evaluation comprises identification of binding characteristics of the protein. In an embodiment, the evaluation comprises identification of interaction of the protein with a second protein.

In an embodiment, the biomolecule is comprised in an aqueous composition. In an embodiment, the aqueous composition is a solution. In an embodiment, the aqueous composition is present at near physiological conditions. In an embodiment, the method is configured for multiple repetitions.

In an embodiment, the method is configured for analyzing the biomolecule in less than 1 minute. In an embodiment, the method is configured for analyzing the biomolecule in less than 2 minutes. In an embodiment, the method is configured for analyzing the biomolecule in less than 5 minutes. In an embodiment, the method is configured for analyzing the biomolecule in less than 10 minutes. In an embodiment, the method is configured for analyzing the biomolecule in less than 30 minutes. In an embodiment, the method is configured for analyzing the biomolecule in less than 60 minutes.

In an embodiment, the analysis is a structural evaluation. In an embodiment, the analysis comprises an optical measurement. In an embodiment, the optical measurement is selected from the group consisting of infrared absorption, interferometric absorption, optical absorption, scattering, fluorescence, nonlinear optical measurements, and any combination thereof.

In an embodiment, the method further comprises a principal component analysis (PCA). In an embodiment, the method further comprises a multiple linear regression (MLR) analysis. In an embodiment, the method further comprises a principal component analysis (PCA) and a multiple linear regression (MLR) analysis.

In an embodiment, the method does not substantially degrade the biomolecule. In an embodiment, the degrading is heat-derived degradation. In an embodiment, the method does not substantially degrade the biomolecule. In an embodiment, the degrading is heat-derived degradation.

In an embodiment, the method does not comprise labeling of the biomolecule. In an embodiment, the method does not comprise labeling of the biomolecule.

In an embodiment, the step of subjecting is performed at a temperature between about 0° C. and about 40° C. In an embodiment, the step of subjecting is performed at a temperature between about 0° C. and about 5° C. In an embodiment, the step of subjecting is performed at a temperature between about 5° C. and about 10° C. In an embodiment, the step of subjecting is performed at a temperature between about 10° C. and about 15° C. In an embodiment, the step of subjecting is performed at a temperature between about 15° C. and about 20° C. In an embodiment, the step of subjecting is performed at a temperature between about 20° C. and about 25° C. In an embodiment, the step of subjecting is performed at a temperature between about 25° C. and about 30° C. In an embodiment, the step of subjecting is performed at a temperature between about 30° C. and about 35° C. In an embodiment, the step of subjecting is performed at a temperature between about 35° C. and about 40° C.

In an embodiment, the step of subjecting is performed at a temperature between about 3° C. and about 8° C. In an embodiment, the step of subjecting is performed at a temperature between about 8° C. and about 13° C. In an embodiment, the step of subjecting is performed at a temperature between about 13° C. and about 18° C. In an embodiment, the step of subjecting is performed at a temperature between about 18° C. and about 23° C. In an embodiment, the step of subjecting is performed at a temperature between about 23° C. and about 28° C. In an embodiment, the step of subjecting is performed at a temperature between about 28° C. and about 33° C. In an embodiment, the step of subjecting is performed at a temperature between about 33° C. and about 38° C.

In an embodiment, the step of subjecting is performed at a temperature below 5° C. In an embodiment, the step of subjecting is performed at a temperature below 10° C. In an embodiment, the step of subjecting is performed at a temperature below 15° C. In an embodiment, the step of subjecting is performed at a temperature below 20° C. In an embodiment, the step of subjecting is performed at a temperature below 25° C. In an embodiment, the step of subjecting is performed at a temperature below 30° C. In an embodiment, the step of subjecting is performed at a temperature below 35° C. In an embodiment, the step of subjecting is performed at a temperature below 40° C.

The following numbered embodiments are contemplated and are non-limiting:
1. A method of evaluating an interaction between a first composition and a second composition, the method comprising the step of subjecting the interaction between the first composition and the second composition to Raman spectroscopy, wherein the step of subjecting is performed at a temperature between about 0° C. and about 40° C.
2. The method of clause 1, any other suitable clause, or any combination of clauses, wherein the first composition is comprised in an aqueous composition.
3. The method of clause 2, any other suitable clause, or any combination of clauses, wherein the aqueous composition is a solution.
4. The method of clause 2, any other suitable clause, or any combination of clauses, wherein the aqueous composition is present at near physiological conditions.
5. The method of clause 1, any other suitable clause, or any combination of clauses, wherein the first composition is a therapeutic agent.
6. The method of clause 1, any other suitable clause, or any combination of clauses, wherein the first composition is a drug.
7. The method of clause 6, any other suitable clause, or any combination of clauses, wherein the drug is a small molecule.
8. The method of clause 6, any other suitable clause, or any combination of clauses, wherein the drug is a biologic.
9. The method of clause 6, any other suitable clause, or any combination of clauses, wherein the drug is a steric inhibitor.
10. The method of clause 1, any other suitable clause, or any combination of clauses, wherein the first composition is an antibody.
11. The method of clause 1, any other suitable clause, or any combination of clauses, wherein the first composition is an enzyme.
12. The method of clause 1, any other suitable clause, or any combination of clauses, wherein the first composition is a protein.
13. The method of clause 1, any other suitable clause, or any combination of clauses, wherein the first composition is a drug target.
14. The method of clause 1, any other suitable clause, or any combination of clauses, wherein the first composition is an antigen.
15. The method of clause 1, any other suitable clause, or any combination of clauses, wherein the first composition is a receptor.
16. The method of clause 1, any other suitable clause, or any combination of clauses, wherein the first composition is an insoluble protein.
17. The method of clause 1, any other suitable clause, or any combination of clauses, wherein the second composition is comprised in an aqueous composition.
18. The method of clause 17, any other suitable clause, or any combination of clauses, wherein the aqueous composition is a solution.
19. The method of clause 17, any other suitable clause, or any combination of clauses, wherein the aqueous composition is present at near physiological conditions.
20. The method of clause 1, any other suitable clause, or any combination of clauses, wherein the second composition is a therapeutic agent.
21. The method of clause 1, any other suitable clause, or any combination of clauses, wherein the second composition is a drug.
22. The method of clause 21, any other suitable clause, or any combination of clauses, wherein the drug is a small molecule.
23. The method of clause 21, any other suitable clause, or any combination of clauses, wherein the drug is a biologic.
24. The method of clause 21, any other suitable clause, or any combination of clauses, wherein the drug is a steric inhibitor.
25. The method of clause 1, any other suitable clause, or any combination of clauses, wherein the second composition is an antibody.
26. The method of clause 1, any other suitable clause, or any combination of clauses, wherein the second composition is an enzyme.
27. The method of clause 1, any other suitable clause, or any combination of clauses, wherein the second composition is a protein.
28. The method of clause 1, any other suitable clause, or any combination of clauses, wherein the second composition is a drug target.
29. The method of clause 1, any other suitable clause, or any combination of clauses, wherein the second composition is an antigen.
30. The method of clause 1, any other suitable clause, or any combination of clauses, wherein the second composition is a receptor.
31. The method of clause 1, any other suitable clause, or any combination of clauses, wherein the second composition is an insoluble protein.
32. The method of clause 1, any other suitable clause, or any combination of clauses, wherein the first composition is a drug and wherein the second composition is a drug target.
33. The method of clause 1, any other suitable clause, or any combination of clauses, wherein the first composition is an antibody and wherein the second composition is an antigen.
34. The method of clause 1, any other suitable clause, or any combination of clauses, wherein the method is configured for multiple repetitions.
35. The method of clause 1, any other suitable clause, or any combination of clauses, wherein the method is configured for therapeutic agent screening for efficacy.
36. The method of clause 1, any other suitable clause, or any combination of clauses, wherein the method is configured for therapeutic agent screening for side effects.
37. The method of clause 1, any other suitable clause, or any combination of clauses, wherein the method is configured for evaluating the interaction in less than 1 minute.
38. The method of clause 1, any other suitable clause, or any combination of clauses, wherein the method is configured for evaluating the interaction in less than 2 minutes.
39. The method of clause 1, any other suitable clause, or any combination of clauses, wherein the method is configured for evaluating the interaction in less than 5 minutes.
40. The method of clause 1, any other suitable clause, or any combination of clauses, wherein the method is configured for evaluating the interaction in less than 10 minutes.
41. The method of clause 1, any other suitable clause, or any combination of clauses, wherein the method is configured for evaluating the interaction in less than 30 minutes.
42. The method of clause 1, any other suitable clause, or any combination of clauses, wherein the method is configured for evaluating the interaction in less than 60 minutes.
43. The method of clause 1, any other suitable clause, or any combination of clauses, wherein the interaction is a structural evaluation.
44. The method of clause 1, any other suitable clause, or any combination of clauses, wherein the evaluation comprises an optical measurement.
45. The method of clause 44, any other suitable clause, or any combination of clauses, wherein the optical measurement is selected from the group consisting of infrared absorption, interferometric absorption, optical absorption, scattering, fluorescence, nonlinear optical measurements, and any combination thereof.
46. The method of clause 1, any other suitable clause, or any combination of clauses, wherein the method further comprises a principal component analysis (PCA).
47. The method of clause 1, any other suitable clause, or any combination of clauses, wherein the method further comprises a multiple linear regression (MLR) analysis.
48. The method of clause 1, any other suitable clause, or any combination of clauses, wherein the method further comprises a principal component analysis (PCA) and a multiple linear regression (MLR) analysis.
49. The method of clause 1, any other suitable clause, or any combination of clauses, wherein the method does not substantially degrade the first composition.
50. The method of clause 49, any other suitable clause, or any combination of clauses, wherein the degrading is heat-derived degradation.
51. The method of clause 1, any other suitable clause, or any combination of clauses, wherein the method does not substantially degrade the second composition.
52. The method of clause 51, any other suitable clause, or any combination of clauses, wherein the degrading is heat-derived degradation.
53. The method of clause 1, any other suitable clause, or any combination of clauses, wherein the method does not comprise labeling of the first composition.
54. The method of clause 1, any other suitable clause, or any combination of clauses, wherein the method does not comprise labeling of the second composition.
55. The method of clause 1, any other suitable clause, or any combination of clauses, wherein the step of subjecting is performed at a temperature between about 0° C. and about 40° C.
56. The method of clause 1, any other suitable clause, or any combination of clauses, wherein the step of subjecting is performed at a temperature between about 0° C. and about 5° C.
57. The method of clause 1, any other suitable clause, or any combination of clauses, wherein the step of subjecting is performed at a temperature between about 5° C. and about 10° C.
58. The method of clause 1, any other suitable clause, or any combination of clauses, wherein the step of subjecting is performed at a temperature between about 10° C. and about 15° C.
59. The method of clause 1, any other suitable clause, or any combination of clauses, wherein the step of subjecting is performed at a temperature between about 15° C. and about 20° C.
60. The method of clause 1, any other suitable clause, or any combination of clauses, wherein the step of subjecting is performed at a temperature between about 20° C. and about 25° C.
61. The method of clause 1, any other suitable clause, or any combination of clauses, wherein the step of subjecting is performed at a temperature between about 25° C. and about 30° C.
62. The method of clause 1, any other suitable clause, or any combination of clauses, wherein the step of subjecting is performed at a temperature between about 30° C. and about 35° C.
63. The method of clause 1, any other suitable clause, or any combination of clauses, wherein the step of subjecting is performed at a temperature between about 35° C. and about 40° C.
64. The method of clause 1, any other suitable clause, or any combination of clauses, wherein the step of subjecting is performed at a temperature between about 3° C. and about 8° C.
65. The method of clause 1, any other suitable clause, or any combination of clauses, wherein the step of subjecting is performed at a temperature between about 8° C. and about 13° C.
66. The method of clause 1, any other suitable clause, or any combination of clauses, wherein the step of subjecting is performed at a temperature between about 13° C. and about 18° C.
67. The method of clause 1, any other suitable clause, or any combination of clauses, wherein the step of subjecting is performed at a temperature between about 18° C. and about 23° C.
68. The method of clause 1, any other suitable clause, or any combination of clauses, wherein the step of subjecting is performed at a temperature between about 23° C. and about 28° C.
69. The method of clause 1, any other suitable clause, or any combination of clauses, wherein the step of subjecting is performed at a temperature between about 28° C. and about 33° C.
70. The method of clause 1, any other suitable clause, or any combination of clauses, wherein the step of subjecting is performed at a temperature between about 33° C. and about 38° C.
71. The method of clause 1, any other suitable clause, or any combination of clauses, wherein the step of subjecting is performed at a temperature below 5° C.
72. The method of clause 1, any other suitable clause, or any combination of clauses, wherein the step of subjecting is performed at a temperature below 10° C.
73. The method of clause 1, any other suitable clause, or any combination of clauses, wherein the step of subjecting is performed at a temperature below 15° C.
74. The method of clause 1, any other suitable clause, or any combination of clauses, wherein the step of subjecting is performed at a temperature below 20° C.
75. The method of clause 1, any other suitable clause, or any combination of clauses, wherein the step of subjecting is performed at a temperature below 25° C.
76. The method of clause 1, any other suitable clause, or any combination of clauses, wherein the step of subjecting is performed at a temperature below 30° C.
77. The method of clause 1, any other suitable clause, or any combination of clauses, wherein the step of subjecting is performed at a temperature below 35° C.
78. The method of clause 1, any other suitable clause, or any combination of clauses, wherein the step of subjecting is performed at a temperature below 40° C.
79. A method of evaluating an interaction between a first biomolecule and a second biomolecule, the method comprising the step of subjecting the interaction between the first biomolecule and the second biomolecule to Raman spectroscopy, wherein the step of subjecting is performed at a temperature between about 0° C. and about 40° C.
80. The method of clause 79, any other suitable clause, or any combination of clauses, wherein the first biomolecule is selected from the group consisting of a protein, a peptide, an amino acid, a nucleic acid, a synthetic analog of a nucleic acid, a sugar, a carbohydrate, and a lipid.
81. The method of clause 79, any other suitable clause, or any combination of clauses, wherein the second biomolecule is selected from the group consisting of a protein, a peptide, an amino acid, a nucleic acid, a synthetic analog of a nucleic acid, a sugar, a carbohydrate, and a lipid.
82. The method of clause 79, any other suitable clause, or any combination of clauses, wherein the first biomolecule is comprised in an aqueous composition.
83. The method of clause 82, any other suitable clause, or any combination of clauses, wherein the aqueous composition is a solution.
84. The method of clause 82, any other suitable clause, or any combination of clauses, wherein the aqueous composition is present at near physiological conditions.
85. The method of clause 79, any other suitable clause, or any combination of clauses, wherein the second biomolecule is comprised in an aqueous composition.
86. The method of clause 85, any other suitable clause, or any combination of clauses, wherein the aqueous composition is a solution.
87. The method of clause 85, any other suitable clause, or any combination of clauses, wherein the aqueous composition is present at near physiological conditions.
88. The method of clause 79, any other suitable clause, or any combination of clauses, wherein the method is configured for multiple repetitions.
89. The method of clause 79, any other suitable clause, or any combination of clauses, wherein the method is configured for therapeutic agent screening for efficacy.
90. The method of clause 79, any other suitable clause, or any combination of clauses, wherein the method is configured for therapeutic agent screening for side effects.
91. The method of clause 79, any other suitable clause, or any combination of clauses, wherein the method is configured for evaluating the interaction in less than 1 minute.
92. The method of clause 79, any other suitable clause, or any combination of clauses, wherein the method is configured for evaluating the interaction in less than 2 minutes.
93. The method of clause 79, any other suitable clause, or any combination of clauses, wherein the method is configured for evaluating the interaction in less than 5 minutes.
94. The method of clause 79, any other suitable clause, or any combination of clauses, wherein the method is configured for evaluating the interaction in less than 10 minutes.
95. The method of clause 79, any other suitable clause, or any combination of clauses, wherein the method is configured for evaluating the interaction in less than 30 minutes.
96. The method of clause 79, any other suitable clause, or any combination of clauses, wherein the method is configured for evaluating the interaction in less than 60 minutes.
97. The method of clause 79, any other suitable clause, or any combination of clauses, wherein the interaction is a structural evaluation.
98. The method of clause 79, any other suitable clause, or any combination of clauses, wherein the evaluation comprises an optical measurement.
99. The method of clause 98, any other suitable clause, or any combination of clauses, wherein the optical measurement is selected from the group consisting of infrared absorption, interferometric absorption, optical absorption, scattering, fluorescence, nonlinear optical measurements, and any combination thereof.
100. The method of clause 79, any other suitable clause, or any combination of clauses, wherein the method further comprises a principal component analysis (PCA).
101. The method of clause 79, any other suitable clause, or any combination of clauses, wherein the method further comprises a multiple linear regression (MLR) analysis.
102. The method of clause 79, any other suitable clause, or any combination of clauses, wherein the method further comprises a principal component analysis (PCA) and a multiple linear regression (MLR) analysis.
103. The method of clause 79, any other suitable clause, or any combination of clauses, wherein the method does not substantially degrade the first biomolecule.
104. The method of clause 103, any other suitable clause, or any combination of clauses, wherein the degrading is heat-derived degradation.
105. The method of clause 79, any other suitable clause, or any combination of clauses, wherein the method does not substantially degrade the second biomolecule.
106. The method of clause 105, any other suitable clause, or any combination of clauses, wherein the degrading is heat-derived degradation.
107. The method of clause 79, any other suitable clause, or any combination of clauses, wherein the method does not comprise labeling of the first biomolecule.
108. The method of clause 79, any other suitable clause, or any combination of clauses, wherein the method does not comprise labeling of the second biomolecule.
109. The method of clause 79, any other suitable clause, or any combination of clauses, wherein the step of subjecting is performed at a temperature between about 0° C. and about 40° C.
110. The method of clause 79, any other suitable clause, or any combination of clauses, wherein the step of subjecting is performed at a temperature between about 0° C. and about 5° C.
111. The method of clause 79, any other suitable clause, or any combination of clauses, wherein the step of subjecting is performed at a temperature between about 5° C. and about 10° C.
112. The method of clause 79, any other suitable clause, or any combination of clauses, wherein the step of subjecting is performed at a temperature between about 10° C. and about 15° C.
113. The method of clause 79, any other suitable clause, or any combination of clauses, wherein the step of subjecting is performed at a temperature between about 15° C. and about 20° C.
114. The method of clause 79, any other suitable clause, or any combination of clauses, wherein the step of subjecting is performed at a temperature between about 20° C. and about 25° C.
115. The method of clause 79, any other suitable clause, or any combination of clauses, wherein the step of subjecting is performed at a temperature between about 25° C. and about 30° C.
116. The method of clause 79, any other suitable clause, or any combination of clauses, wherein the step of subjecting is performed at a temperature between about 30° C. and about 35° C.
117. The method of clause 79, any other suitable clause, or any combination of clauses, wherein the step of subjecting is performed at a temperature between about 35° C. and about 40° C.
118. The method of clause 79, any other suitable clause, or any combination of clauses, wherein the step of subjecting is performed at a temperature between about 3° C. and about 8° C.
119. The method of clause 79, any other suitable clause, or any combination of clauses, wherein the step of subjecting is performed at a temperature between about 8° C. and about 13° C.
120. The method of clause 79, any other suitable clause, or any combination of clauses, wherein the step of subjecting is performed at a temperature between about 13° C. and about 18° C.
121. The method of clause 79, any other suitable clause, or any combination of clauses, wherein the step of subjecting is performed at a temperature between about 18° C. and about 23° C.
122. The method of clause 79, any other suitable clause, or any combination of clauses, wherein the step of subjecting is performed at a temperature between about 23° C. and about 28° C.
123. The method of clause 79, any other suitable clause, or any combination of clauses, wherein the step of subjecting is performed at a temperature between about 28° C. and about 33° C.
124. The method of clause 79, any other suitable clause, or any combination of clauses, wherein the step of subjecting is performed at a temperature between about 33° C. and about 38° C.
125. The method of clause 79, any other suitable clause, or any combination of clauses, wherein the step of subjecting is performed at a temperature below 5° C.
126. The method of clause 79, any other suitable clause, or any combination of clauses, wherein the step of subjecting is performed at a temperature below 10° C.
127. The method of clause 79, any other suitable clause, or any combination of clauses, wherein the step of subjecting is performed at a temperature below 15° C.
128. The method of clause 79, any other suitable clause, or any combination of clauses, wherein the step of subjecting is performed at a temperature below 20° C.
129. The method of clause 79, any other suitable clause, or any combination of clauses, wherein the step of subjecting is performed at a temperature below 25° C.
130. The method of clause 79, any other suitable clause, or any combination of clauses, wherein the step of subjecting is performed at a temperature below 30° C.
131. The method of clause 79, any other suitable clause, or any combination of clauses, wherein the step of subjecting is performed at a temperature below 35° C.
132. The method of clause 79, any other suitable clause, or any combination of clauses, wherein the step of subjecting is performed at a temperature below 40° C.
133. A method of analyzing a biomolecule, the method comprising the step of subjecting the biomolecule to Raman spectroscopy, wherein the step of subjecting is performed at a temperature between about 0° C. and about 40° C.
134. The method of clause 133, any other suitable clause, or any combination of clauses, wherein the biomolecule is selected from the group consisting of a protein, a peptide, an amino acid, a nucleic acid, a synthetic analog of a nucleic acid, a sugar, a carbohydrate, and a lipid.
135. The method of clause 133, any other suitable clause, or any combination of clauses, wherein the biomolecule is a protein.
136. The method of clause 135, any other suitable clause, or any combination of clauses, wherein the analyzing provides evaluation of the protein.
137. The method of clause 136, any other suitable clause, or any combination of clauses, wherein the evaluation comprises identification of a plurality of amino acids of the protein.
138. The method of clause 137, any other suitable clause, or any combination of clauses, wherein the evaluation comprises quantification of the plurality of amino acids of the protein.
139. The method of clause 137, any other suitable clause, or any combination of clauses, wherein the evaluation comprises identification of a secondary structure of the plurality of amino acids.
140. The method of clause 136, any other suitable clause, or any combination of clauses, wherein the evaluation comprises identification of a primary structure of the protein.
141. The method of clause 136, any other suitable clause, or any combination of clauses, wherein the evaluation comprises identification of a secondary structure of the protein.
142. The method of clause 136, any other suitable clause, or any combination of clauses, wherein the evaluation comprises identification of a tertiary structure of the protein.
143. The method of clause 136, any other suitable clause, or any combination of clauses, wherein the evaluation comprises identification of a quaternary structure of the protein.
144. The method of clause 136, any other suitable clause, or any combination of clauses, wherein the evaluation comprises identification of binding characteristics of the protein.
145. The method of clause 136, any other suitable clause, or any combination of clauses, wherein the evaluation comprises identification of interaction of the protein with a second protein.
146. The method of clause 133, any other suitable clause, or any combination of clauses, wherein the biomolecule is comprised in an aqueous composition.
147. The method of clause 146, any other suitable clause, or any combination of clauses, wherein the aqueous composition is a solution.
148. The method of clause 146, any other suitable clause, or any combination of clauses, wherein the aqueous composition is present at near physiological conditions.
149. The method of clause 133, any other suitable clause, or any combination of clauses, wherein the method is configured for multiple repetitions.
150. The method of clause 133, any other suitable clause, or any combination of clauses, wherein the method is configured for analyzing the biomolecule in less than 1 minute.
151. The method of clause 133, any other suitable clause, or any combination of clauses, wherein the method is configured for analyzing the biomolecule in less than 2 minutes.
152. The method of clause 133, any other suitable clause, or any combination of clauses, wherein the method is configured for analyzing the biomolecule in less than 5 minutes.
153. The method of clause 133, any other suitable clause, or any combination of clauses, wherein the method is configured for analyzing the biomolecule in less than 10 minutes.
154. The method of clause 133, any other suitable clause, or any combination of clauses, wherein the method is configured for analyzing the biomolecule in less than 30 minutes.
155. The method of clause 133, any other suitable clause, or any combination of clauses, wherein the method is configured for analyzing the biomolecule in less than 60 minutes.
156. The method of clause 133, any other suitable clause, or any combination of clauses, wherein the analysis is a structural evaluation.
157. The method of clause 133, any other suitable clause, or any combination of clauses, wherein the analysis comprises an optical measurement.
158. The method of clause 157, any other suitable clause, or any combination of clauses, wherein the optical measurement is selected from the group consisting of infrared absorption, interferometric absorption, optical absorption, scattering, fluorescence, nonlinear optical measurements, and any combination thereof.
159. The method of clause 133, any other suitable clause, or any combination of clauses, wherein the method further comprises a principal component analysis (PCA).
160. The method of clause 133, any other suitable clause, or any combination of clauses, wherein the method further comprises a multiple linear regression (MLR) analysis.
161. The method of clause 133, any other suitable clause, or any combination of clauses, wherein the method further comprises a principal component analysis (PCA) and a multiple linear regression (MLR) analysis.
162. The method of clause 133, any other suitable clause, or any combination of clauses, wherein the method does not substantially degrade the biomolecule.
163. The method of clause 162, any other suitable clause, or any combination of clauses, wherein the degrading is heat-derived degradation.
164. The method of clause 133, any other suitable clause, or any combination of clauses, wherein the method does not substantially degrade the biomolecule.
165. The method of clause 164, any other suitable clause, or any combination of clauses, wherein the degrading is heat-derived degradation.
166. The method of clause 133, any other suitable clause, or any combination of clauses, wherein the method does not comprise labeling of the biomolecule.
167. The method of clause 133, any other suitable clause, or any combination of clauses, wherein the method does not comprise labeling of the biomolecule.
168. The method of clause 133, any other suitable clause, or any combination of clauses, wherein the step of subjecting is performed at a temperature between about 0° C. and about 40° C.
169. The method of clause 133, any other suitable clause, or any combination of clauses, wherein the step of subjecting is performed at a temperature between about 0° C. and about 5° C.
170. The method of clause 133, any other suitable clause, or any combination of clauses, wherein the step of subjecting is performed at a temperature between about 5° C. and about 10° C.
171. The method of clause 133, any other suitable clause, or any combination of clauses, wherein the step of subjecting is performed at a temperature between about 10° C. and about 15° C.
172. The method of clause 133, any other suitable clause, or any combination of clauses, wherein the step of subjecting is performed at a temperature between about 15° C. and about 20° C.
173. The method of clause 133, any other suitable clause, or any combination of clauses, wherein the step of subjecting is performed at a temperature between about 20° C. and about 25° C.
174. The method of clause 133, any other suitable clause, or any combination of clauses, wherein the step of subjecting is performed at a temperature between about 25° C. and about 30° C.
175. The method of clause 133, any other suitable clause, or any combination of clauses, wherein the step of subjecting is performed at a temperature between about 30° C. and about 35° C.
176. The method of clause 133, any other suitable clause, or any combination of clauses, wherein the step of subjecting is performed at a temperature between about 35° C. and about 40° C.
177. The method of clause 133, any other suitable clause, or any combination of clauses, wherein the step of subjecting is performed at a temperature between about 3° C. and about 8° C.
178. The method of clause 133, any other suitable clause, or any combination of clauses, wherein the step of subjecting is performed at a temperature between about 8° C. and about 13° C.
179. The method of clause 133, any other suitable clause, or any combination of clauses, wherein the step of subjecting is performed at a temperature between about 13° C. and about 18° C.
180. The method of clause 133, any other suitable clause, or any combination of clauses, wherein the step of subjecting is performed at a temperature between about 18° C. and about 23° C.
181. The method of clause 133, any other suitable clause, or any combination of clauses, wherein the step of subjecting is performed at a temperature between about 23° C. and about 28° C.
182. The method of clause 133, any other suitable clause, or any combination of clauses, wherein the step of subjecting is performed at a temperature between about 28° C. and about 33° C.
183. The method of clause 133, any other suitable clause, or any combination of clauses, wherein the step of subjecting is performed at a temperature between about 33° C. and about 38° C.
184. The method of clause 133, any other suitable clause, or any combination of clauses, wherein the step of subjecting is performed at a temperature below 5° C.
185. The method of clause 133, any other suitable clause, or any combination of clauses, wherein the step of subjecting is performed at a temperature below 10° C.
186. The method of clause 133, any other suitable clause, or any combination of clauses, wherein the step of subjecting is performed at a temperature below 15° C.
187. The method of clause 133, any other suitable clause, or any combination of clauses, wherein the step of subjecting is performed at a temperature below 20° C.
188. The method of clause 133, any other suitable clause, or any combination of clauses, wherein the step of subjecting is performed at a temperature below 25° C.
189. The method of clause 133, any other suitable clause, or any combination of clauses, wherein the step of subjecting is performed at a temperature below 30° C.
190. The method of clause 133, any other suitable clause, or any combination of clauses, wherein the step of subjecting is performed at a temperature below 35° C.
191. The method of clause 133, any other suitable clause, or any combination of clauses, wherein the step of subjecting is performed at a temperature below 40° C.

### EXAMPLES

### Example 1

### Exemplary Experimental Procedures in Examples 2-4

### Sample Preparation for Examples 2-4

The instant example provides exemplary materials and methods utilized in Examples 2-4 as described herein.

SpA (Cat. No. p6031), TTR (Cat. No. P1742), DNP (Cat. No. D198501) and biotin (Cat. No. B4501) were purchased from Sigma Aldrich. The receptor-binding domain (RBD) (residues 319-541) of the SARS CoV-2 spike(S) protein (GenBank: QHD43416) purchased from BEI resources, Human Anti-SARS CoV S IgG1 (CR3022) purchased from the Absolute Antibody, Mouse Anti-SARS CoV-2 Spike Neutralizing IgG2b (clone NN68) purchased from the Creative Diagnostics. Streptavidin (Cat. No. 21135) and Goat Anti-Human IgG (GAH) (Cat. No. 62-8400) purchased from the Thermo Fisher Scientific. The RBD and three antibodies were used as received without additional purification. Sterilized 0.01 M phosphate buffered saline (PBS) of pH 7.4 was used as both protein and drug solvent. PBS was used to prepare TTR (20 μM), DNP (20 μM), streptavidin (3 mg/ml), biotin (0.055 mg/ml) and SpA (3 mg/ml) solutions. TTR and DNP solutions were mixed to a 1:1 molar ratio and stored at 4° C. Raman measurements were performed of 10 μL samples from the mix at 0-1 hours, 2-3 hours and 24 after their mixing. Streptavidin and biotin solution was mixed to a 1:4 (due to tetrameric structure of streptavidin) molar ratio and incubated overnight at 4° C. This mix's final concentration was 1.53 mg/ml. The original RBD and each of the three antibody solutions were 1 mg/mL in 0.01 M PBS buffer. The solutions were concentrated 3 times using a Amicon Ultra-0.5 centrifugal filter (Cat. no. UFC500308), and their final concentrations were 3 mg/ml. Each antigen (RBD or SpA) and antibody (CR3022, NN68, or GAH) were mixed at a molar ratio of 1:1 and incubated overnight at 4° C. The final concentrations of the RBD+IgG mixes were 1.75 mg/ml, and the SpA+IgG mixes concentrations were 1.875 mg/ml.

### Apparatus and Software as Used in Examples 2-4

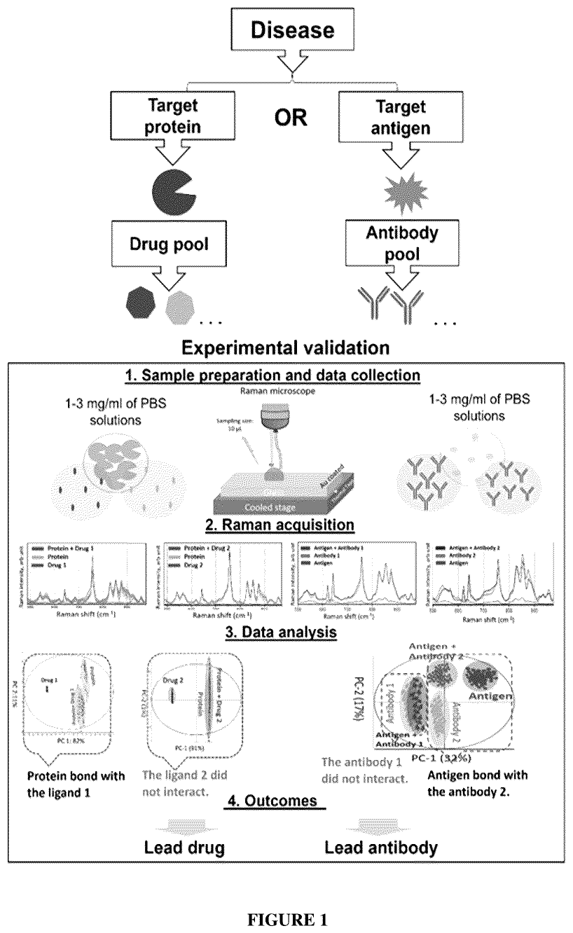

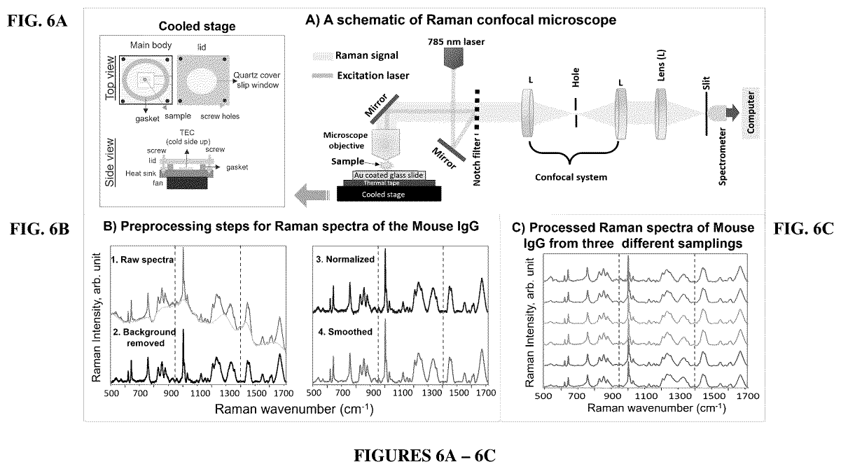

The protein samples were studied using LabRam Raman confocal system from Horiba. Overall microscope setup is shown in FIG. 1 as well as FIG. 6A.

The excitation laser was 785 nm. Raman measurements were taken from a ten microliter drop of solution deposited on Au coated glass slide (Ted Pella No 26002-G). The cooled Au thin layer on a glass slide served a dual purpose for dissipating thermal energy from the excitation laser and blocking the fluorescent background from the glass substrate. The laser was focused to a one-micron spot size inside the liquid samples using a 100× microscope objective lens with 0.75 NA. The acquisition time was 5 seconds and averaged across 12 spectra. The laser power was 7 mW to minimize sample damage by the laser excitation. Spontaneous Raman generation is not an efficient process. Therefore, for the small quantities of material used in Raman microscopy, relatively high laser intensities are often employed to see a high-quality Raman spectrum. Even though the sample was excited at an infrared wavelength of 785 nm, which is well inside the biological transparency window, significant laser heating was seen. In particular, for a sample at room temperature, the Raman spectra changed with time, especially for the RBD protein sample, which was attributed to protein denaturation. To address sample heating, a simple, compact cooler driven by a thermoelectric device was developed. The cooler was able to rapidly cool to near 10° C. in about 10 seconds. To avoid water condensation, the sample was hermetically sealed using a window including a microscope cover slip bonded to a clamp device that could be quickly opened and closed. Due to the low clearance of the microscope stage, the cooler was made to be highly compact. The final version of the cooler is shown in FIG. 6A. On the bottom is a small fan and heat sink. The coverslip which gives optical access to the sample, is sealed with gasket-glue. Another gasket is placed between the two metal plates. Since the glass slide has poor thermal conductivity, thermal two-sided tape was used to contact between the cool side of the TEC and the slide. In addition, possible interference from the gold layer was eliminated by performing dry-state measurements of the samples whereby the sample drop was allowed to dry in air onto the gold layer. Inconsistencies in Raman spectra due to random orientation of dried protein samples rather than interference by the gold layer was observed.

The backgrounds of the Raman raw spectra were estimated by the “Estimated Background” function of the Mathematica 12.1 (Wolframs). The software is based on a statistics-sensitive nonlinear iterative peak-clipping algorithm that estimates background while trying to preserve features of the spectra. After the estimated backgrounds were removed from the raw spectra, the background removed spectra were normalized by unit-vector (vector norm) using the OriginPro software. Furthermore, the normalized spectra were smoothed with Savitsky-Golay algorithm with 15 adjacent points by the OriginPro software. FIG. 6B shows the preprocessing steps of the Raman spectrum for the mouse IgG sample. The processed Raman spectra from 3 different samplings are depicted in FIG. 6C.

### PCA Analysis

The Raman spectra of the mixtures of protein-ligand and protein-protein are very complex. Therefore, a univariate presentation of their Raman spectra is not feasible, therefore, a multivariate method was chosen using principal component analysis (PCA). PCA is a statistical method that increases interpretability in a dataset while minimizing loss of information, allowing for the factors that affect spectral variation in the data to be shown. The data matrix is created where the rows contain sample information and the columns (variables) are Raman intensities on corresponding wavenumber. PCA aligns a set of axes, called principal components (PCs), with the maximal directions of variance within a dataset using the covariance matrix of the original data. PCA then results in three matrices that contain the scores, the loadings, and the residuals. The score matrix indicates the difference among groups of samples, and the loading plot corresponds to the variance in the Raman spectra. The use of PCA thus allows for better interpretation of complex Raman spectra from different antigen and antibody mixes by showing differences between the samples and connecting them to differences in the variables defining a sample. Past work has shown the successful application of PCA to interpret spectral variation. The PCA analysis was performed by Aspen Unscrambler software.

### Example 2

### TRIP Detection of Time-Dependent Protein-Drug Binding

The Raman spectral region between 500 cm⁻¹ and 1700 cm⁻¹ is the richest with respect to information about proteins. It is called the fingerprint region, as it includes the vibrational modes of amino acids and their secondary structures. A full spectral assignment can be found in Table 1.

TABLE 1
Raman band assignments of amino acids and secondary structures.

| Band cm⁻¹ | # | Vibrational mode assignment | Band cm⁻¹ | # | Vibrational mode assignment |
|---|---|---|---|---|---|
| Tryptophan | | | Phenylalanine | | |
| 757 | 1 | Benzene stretch/pyrrole in- | 622 | 1 | Ring deformation |
| | | phase breathing | | | |
| 877 | 2 | N—H bending, indole ring | 1002 | 2 | Symmetric ring breathing, vibration |
| | | vibration | | | |
| 1010 | 3 | Pyrrole ring out-of-phase | 1030 | 3 | In-p; ane CH deformation |
| | | breathing | | | |
| 1341 | 4 | Fermi resonance between N—C | 1201 | 4 | Phenyl C stretching |
| | | in pyrrole ring | | | |
| 1358 | 4 | Fermi resonance between N—C | 1585 | 5 | Ring stretch, doublet |
| | | in pyrrole ring | | | |
| 1555 | 5 | C—C stretching, pyrrole ring | 1605 | 6 | Ring stretch, doublet |
| Tyrosine | | | Other amino acids | | |
| 643 | 1 | In-plane ring vibration | 543/563 | | O═C—OH deformation |
| | | | | | Threonine |
| 828 | 2 | Tyrosine doublet/phenol ring | 744 | | C—OH twisting |
| | | breathing | | | Threonine |
| 858 | 2 | Tyrosine doublet/phenol ring | 897 | | C—C—O stretching |
| | | breathing | | | Threonine |
| 1175 | 3 | CH₂ twist and rock, CH—NH₂ | 655 | | C—S stretching |
| | | | | | Cysteine |
| 1206 | 4 | Phenyl C stretching | 705 | | C—S stretching |
| | | | | | Cysteine |
| 1260 | 5 | Ring stretch, benzene derivate | 655 | | CH₂—S stretching |
| | | | | | Methionine |
| 1615 | 6 | Ring stretch, benzene derivate | 725 | | S—CH stretching |
| | | | | | Methionine |

The main advantage of Raman spectroscopy is its faster spectral collection time compared to X-ray/Neutron Scattering and Cryo-electron microscopy, significantly with little to no sample preparation (water does not significantly interfere with the signal, as, for example, in infrared spectroscopy). This makes it a strong candidate for real-time analysis. In order to use Raman microscopy to gain quantitative information about the relative amount of protein and ligand in a complex, the Raman scattering intensities (cross sections) of both the protein and ligand should be known. Here, Raman measurements were directly obtained from equimolar PBS solutions of the protein, ligand, and their mixes.

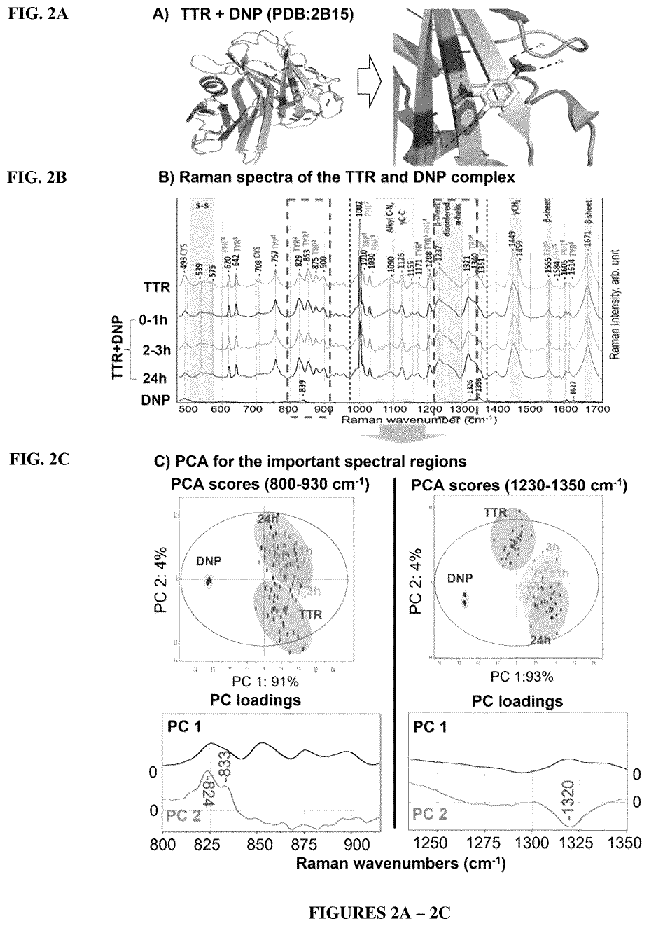

First the binding interactions of 2,4 dinitrophenol (DNP) to transthyretin (TTR) was evaluated, in particular to investigate the time-dependent binding between TTR and DNP and the first Raman microscopic study of the pair in their aqueous solutions. Because of their importance in medical field, their binding interactions were previously studied using a variety of techniques, and their dehydrated complexes investigated by Raman microscopy. Here, the time-dependent binding interactions between TTR and DNP was investigated. Their binding interaction was previously studied by X-ray crystallography, and illustrated in FIG. 2A.

FIG. 2B shows the Raman spectra (with standard errors shaded) taken from 20 M of TTR solution, 20 μM of DNP solution and 20 μM TTR+20 μM DNP solution at 0-1 hour, 2-3 hours, and 24 hours (after the initial mixing). Note that the data is divided into three spectral ranges due to the spectrometer being automatically re-adjusted for each region by the commercial Raman spectrometer (Lab-Ram from Horiba). Note that the Raman spectra of DNP were nearly invisible compared to TTR (FIG. 2B), so that the spectral changes in the mixes are due to the effects of binding. Comparing Raman spectra of TTR and the mixes, clearly shows significant spectral changes in the spectral regions of 800-930 cm⁻¹ and 1230-1350 cm⁻¹ which are evidence of binding-induced interactions between the DNP and the TTR. PCA of the Raman data for both regions are shown in FIG. 2C. Considering the Raman data were obtained from three different days, the PCA clusters the repeats from the same sample, meaning the data were highly reproducible. Both PC1 components separated DNP from other samples very well (FIG. 2C).

In the first spectral region, the clusters of the TTR and the DNP+TTR mixes were clearly separated by PC2 component, but the clusters of the mixes for 0-1 hours, 2-3 hours and 24 hours overlapped (FIG. 2C). In this region, the bound DNP samples were in the positive side (positive side from separating line at zero) of PC2, meaning that the positive peaks (red numbered) of the PC2 loading are changed the for the bound protein samples. Especially, the bound DNP's phenolic ring's OH stretching mode at 824 cm⁻¹ enhanced due to forming a hydrogen bond with TTR's Serine 117 (FIG. 2A). The second highest peak of the PC2 loading was at 833 cm⁻¹. DNP's in-plane bending mode of the two NO₂ (nitro) groups at 839 cm⁻¹ shifted to 833 cm⁻¹ and enhanced when these nitro groups formed hydrogen bonds with TTR's serine 117, alanine 108 and two free water molecules (FIG. 2A).

Interestingly, the PC2 component of the second spectral region (FIG. 2C), separates the unbound protein cluster from the bound protein clusters and additionally, the 24 hour-bound cluster from other bound clusters. This indicates the binding between DNP and the protein was enhanced over time. In particular, the 1320 cm⁻¹ line was heavily weighted in PC2, where the bound DNP samples became more negative meaning that the strength of the binding increased in 24 hours. The line is implicated in the DNP's stretching mode between the aromatic ring and two NO₂ (nitro group) at 1320-1330 cm⁻¹. It has a Raman shift of 1320 cm⁻¹ in the bound DNP solutions (FIG. 2C) which is clearly shifted relative to the corresponding spectra of the unbound DNP solution at 1326 cm⁻¹ (FIG. 2B). This low-frequency shift is possibly due to hydrogen bonds that are expected to form between DNP's two nitro groups and TTR's serine 117, alanine 108, two free water molecules (FIG. 2A) and its intensity enhanced from 0 hour to 24 hours after their binding.

In conclusion, DNP's two nitro groups' stretching mode from the aromatic ring changed over 24 hours but their in-plane bending mode did not change after initial binding. These results, especially in the last spectral region, demonstrate the TRIP technique's capability to successfully detect the time-dependent binding interactions between the TTR and DNP solutions.

### Example 3

### TRIP Detection of Static Protein-Drug Binding

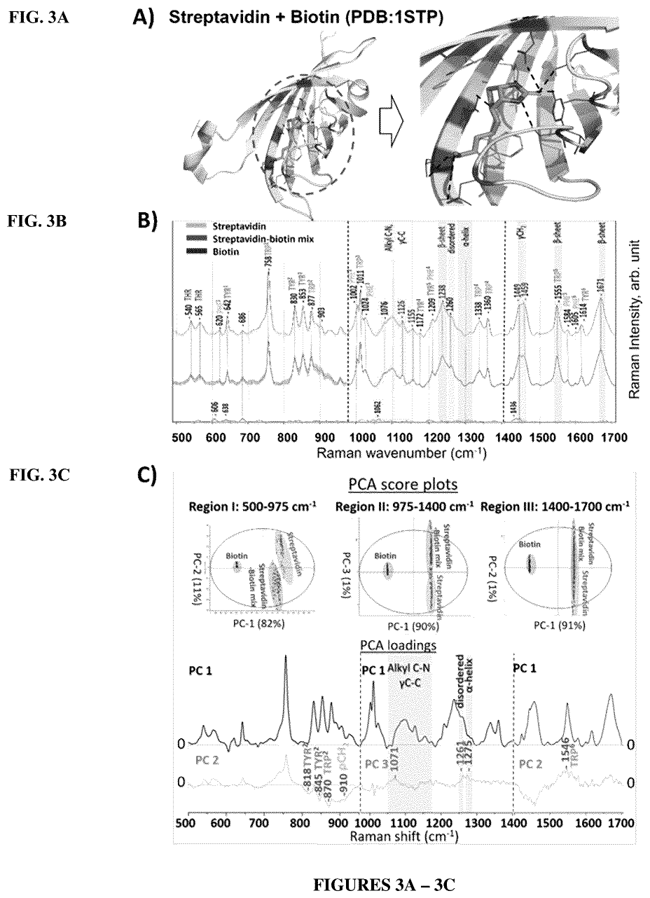

Next, the streptavidin-biotin complex was investigated to demonstrate the power of the TRIP technique, in particular to investigate the binding interactions between streptavidin and biotin in aqueous solutions using Raman microscopy. Their binding interaction in anhydrous was studied previously using the difference-Raman techniques. The strong non-covalent binding of biotin to streptavidin derives from multiple interactions between the streptavidin and biotin, as illustrated in FIG. 3A.

Biotin's Raman spectra are nearly invisible compared to streptavidin (FIG. 3B), so the spectral changes in their mixes are due to binding. Application of PCA for the three spectral regions and their results are shown in FIG. 3C. In all regions the PC1 components separated biotin from bound and unbound streptavidin samples. To separate the bound from unbound streptavidin spectra it is seen that PC2, informed by PC1, works in region I of the spectra. In this region, the negative peaks (red numbers in FIG. 3B) of the PC2 loading are changed when biotin bound streptavidin. The strongest negative peak in this loading was the tryptophan (Trp) band at 870 cm⁻¹ which is due to the N—H bending of the indole ring. This band shifted from 877 cm⁻¹ to 870 cm⁻¹ for unbound versus bound in the streptavidin solutions. This band is sensitive to the hydrogen bonding and implicated in protein-ligand binding. Due to the protein-ligand binding, both the frequency shift and strength of the band changed, indicating that strong hydrogen bonding occurred at the N—H group. This means at least one tryptophan molecule of the streptavidin is involved in hydrogen bonding with the biotin, consistent with the X-ray crystallography data which indicated the presence of four tryptophan (Trp-79, 92, 108, and 120) residues in the biotin binding site of streptavidin (FIG. 3A). The next strongest negative peaks of the PC2 loadings were the tyrosine's Fermi doublet at 845 cm⁻¹ and 818 cm⁻¹ that were shifted from 853 and 830, respectively, for the bound streptavidin solutions. This doublet's intensity ratio (1850/1828) is sensitive to the hydrogen bonding of the phenolic OH group of tyrosine. The same X-ray crystallography study additionally showed that one tyrosine (Tyr-43) formed a hydrogen bond with biotin (FIG. 3A). The next binding relevant peak was a broad spectral area centered at 910 cm⁻¹, which correspond to CH₂ deformation (pCH₂), and its intensity increased for the bound streptavidin samples. In region II, positive PC-3 component alone separates the bound and unbound spectra, and this component explained 1% of the variance of the data. The positive peaks of the PC-3 loading correspond to the secondary structures including disordered at 1260 cm⁻¹ and alpha-helix at 1275 cm⁻¹. These secondary structure changes could indicate an interaction between biotin and the alpha helix of streptavidin. In region III, the separation is poor for PCA components. In contrast to the prior difference-Raman study of this interaction, the samples do not have to be dried, and the results show statistically reliable measurements using TRIP.

### Example 4

### TRIP Detection of Antigen-Antibody Binding

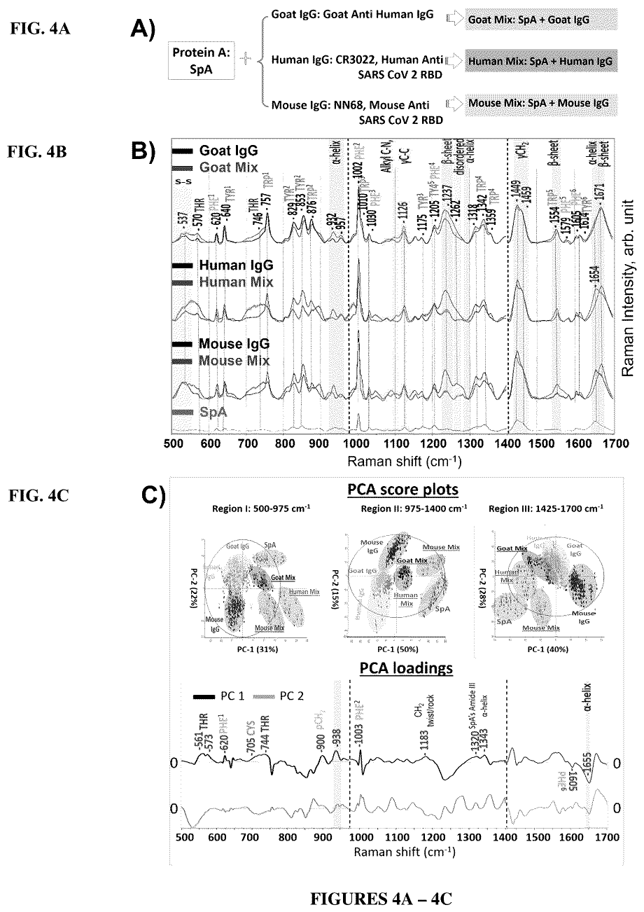

Monoclonal antibodies offer a major advantage in drug discovery, and it is easy to quickly make many new antibodies. However, the process of assessing antibodies to find promising drug candidates is both time-consuming and expensive and some prospects fail to be considered. Here a drug screening technique that is time-saving and cost-effective is proposed. To show the ability of TRIP to work with more complex molecules, the binding interactions between protein A (SpA) and three antibodies (two monoclonals and one polyclonal) were studied, in particular to investigate the binding interactions between SpA and monoclonal/polyclonal antibodies in their aqueous solution using Raman microscopy. FIG. 4 examines the interactions of antibodies with SpA.

FIG. 4A lists the experimental samples of the study. FIG. 4B shows the measured Raman spectra from the experimental samples. The significant spectral changes are observed between the Raman spectra of unbound and bound antibodies for the three antibody complexes in FIG. 4B. This means SpA bonded with each of the three antibodies. The PCA of Raman data for these complexes are shown in FIG. 4C. The PC1 components are separating the bound antibody samples from unbound antibodies in all spectral regions and the relevant peaks are numbered in red in the PC1 loadings. All samples separated into clusters with minimal overlap, except for the goat and the human antibodies. Nonetheless, they partially separated in regions II and III. Interestingly, these two antibodies cleanly separated when SpA is mixed in, especially in the main “fingerprint” region I. Here it should be noted that the goat antibodies are polyclonal, whereas the human and mouse antibodies are monoclonal. The strongest relevant Raman peaks for the bound antibodies were the α-helix's CH₃ groups at 938, the Amide III region at 1320-1340 and the amide I region at 1655 cm⁻¹ bands which were observed in the SpA spectra (FIG. 4B). This indicates a-helices increased in all bound antibodies due to their bonding with the alpha helical SpA. Also, the band at 900 cm⁻¹ assigned to the CH₂ deformation were increased in the bound antibodies. A similar increase for the pCH₂ band in the bound streptavidin sample (FIG. 3C) was observed. The next important peaks for the bound antibodies were Phenylalanine's 620, 1003, and 1605 cm⁻¹ bands. Their intensities were increased in all bound antibodies. The phenylalanine's 1003 peak is sensitive to the hydrophobicity of the local environment. This means the binding between SpA and IgG could be partially driven by hydrophobicity. The region from 705 to 744 cm⁻¹ correspond to C—S stretching of cysteine, threonine's C—OO wagging and C—OH stretching. The intensities of these bands were increased in the bound antibodies. Also, the intensities of the other two threonine bands at 561 and 573 cm⁻¹ corresponding to C—C stretching and C—OOH stretching of threonine increased. The last relevant peak was at 1183 cm⁻¹ which corresponds to CH₂ twist and rock of multiple amino acids.

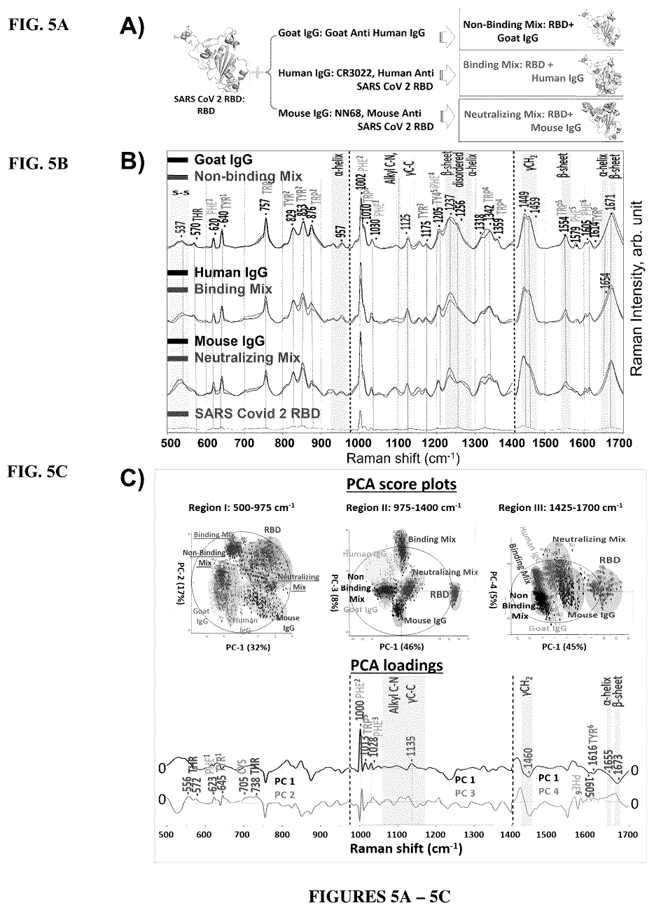

Lastly, the technique was applied to an unknown interaction, the interactions of SARS Cov 2 spike protein receptor binding domain (RBD) with the three antibodies that were used in the previous experiment with SpA. This examined the binding interactions between SARS Cov 2 RBD and antibodies in their aqueous solution using Raman microscopy. These two antigens bind with different parts of antibodies. SpA binds with the FC region of antibodies, while RBD binds with their Fab region. The goat IgG did not bind with RBD, whereas the human IgG and mouse IgG did bind. Also, the mouse IgG neutralized RBD by binding its ACE 2 region. For simplification, mixes were named as follows: the mix of RBD and goat IgG as non-binding mix, the mix of RBD and Human IgG as binding mix and the mix of RBD and mouse IgG as neutralizing mix. Of note, the RBD binding sites to human IgG and the ACE 2 binding sites of a neutralizing IgG were previously studied by X-ray crystallography. The RBD and antibody experimental samples are listed in FIG. 5A.

The Raman spectra taken from the experimental samples are shown in FIG. 5B. Examination of the Raman spectra in FIG. 5B shows a small difference in the spectrum for the goat antibody, but larger differences for the other two antibodies, which are similar in most spectral regions, yet are clearly not identical. Note here that the intensities of the spectral changes for the RBD bound antibody samples (FIG. 5B) were much smaller than the intensities of the spectral changes in the SpA bound antibody samples (FIG. 4B). FIG. 5C shows the PCAs of the Raman data where the PC2, 3 & 4 components give separation in a particular spectral region. Here it is seen that in all cases the PCA cannot distinguish well between the cluster of the goat antibodies (grey) and the cluster of the non-binding mix (black) in FIG. 5C. This is as expected since the goat antibodies are considered non-interacting, and therefore, should not bind. In contrast, the human and the mouse antibodies separate well after mixing with Covid 2 RBD. The relevant peaks separating the bound antibodies from the unbound antibodies are numbered and colored in red as shown in FIG. 5C. As seen with the SpA-bound antibody samples, phenylalanine's 623, 1000, 1028 and 1605 cm⁻¹ bands, threonine bands at 556 and 572 cm⁻¹ and the spectral region between 705 cm⁻¹ to 738 cm⁻¹ are increased for the RBD-bound antibody samples. The spectral changes that differed between the RBD-bound antibodies and the SpA-bound antibodies were the intensity increases in tyrosine's para-substituted benzene ring at 645 cm⁻¹ and tyrosine's ring stretch at 1616 cm⁻¹. These tyrosine vibrational modes were previously studied for the hydrogen bonding of tyrosine. Also, the changes in the tryptophan's ring breathing at 1013 cm⁻¹ happened in the bound samples and this band is sensitive to the cation-pi interaction. The binding interaction between the human IgG and RBD was studied via X-ray crystallography, and it showed that 2 tryptophan and 4 tyrosine molecules are involved, with direct binding between them. The numerous Raman peaks in the relevant PC loadings correspond to secondary structures such as alkyl C—N or backbone skeletal γC—C bands at 1083 cm⁻¹, aliphatic side chain at 1460 cm⁻¹, the B-sheets at 1673 cm⁻¹, and a-helices at 1655 cm⁻¹ for the RBD bound antibodies.

### Example 5

### Exemplary Experimental Procedures for Examples 6-10

### Sample Preparation as in Examples 6-10

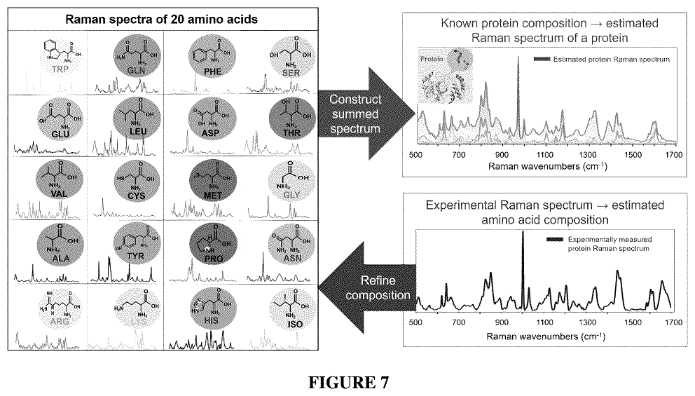

The instant example provides exemplary materials and methods utilized in Examples 6-10 as described herein. A visual representation of the examples is shown in FIG. 7.

L-Alanine (Cat. No. A7627), L-Arginine (Cat. No. A5006), L-Asparagine (Cat. No. A0884), L-Aspartic acid (Cat. No. A9256), L-Cysteine (Cat. No. 168149), L-Glutamic acid (Cat. No. G1251), L-Glutamine (Cat. No. G3126), L-Glycine (Cat. No. G8898), L-Histidine (Cat. No. H8000), L-Isoleucine (Cat. No. 12752), L-Lysine (Cat. No. L5501), L-Methionine (Cat. No. M9625), L-Phenylalanine (P2126), L-Proline (Cat. No. P0380), L-Serine (Cat. No. S4500), L-Threonine (Cat. No. T8625), L-Tryptophan (Cat. No. T0254), L-Tyrosine (Cat. No. T3754), L-Valine (Cat. No. V0500), penta-alanine (Cat. No A5025), insulin (Cat. No. 10908), lysozyme (Cat. No. 10837059001), transthyretin (Cat. No. P1742) and SpA (Cat. No P6031) were purchased from Sigma Aldrich. The receptor-binding domain (RBD) (residues 319-541) of the SARS CoV-2 spike(S) protein (GenBank: QHD43416) purchased from BEI resources, Human Anti-SARS CoV S IgG1 (CR3022) purchased from the Absolute Antibody, Mouse Anti-SARS CoV-2 Spike Neutralizing IgG2b (clone NN68) purchased from the Creative Diagnostics. Streptavidin (Cat. No. 21135) purchased from the Thermo Fisher Scientific. The RBD and two antibodies were used as received without purification. Sterilized 0.01 M phosphate buffered saline (PBS) of pH 7.42 was used mainly as the amino acid and protein solvent. Some amino acids solubility was low in aqueous solution and the addition of 0.1M HCl assisted in their solubilization. The penta-alanine solution was prepared in 1M HCl solution and its concentration was 134 mM. PBS was used to prepare insulin, lysozyme, streptavidin, and SpA solutions at 3 mg/ml and transthyretin solution was made in PBS solution at 1 mg/ml. The amino acid solutions were 180 mM. The original RBD and three antibody concentrations in solution were 1 mg/mL in 0.01 M PBS buffer. The solutions were concentrated 3 times using the Amicon Ultra-0.5 centrifugal filter (Cat. no. UFC500308), and their final concentrations were 3 mg/mL. Its original concentration was 8.9 mg/mL and it was diluted to 1 μM in PBS for this study.

### Apparatus and Software for Examples 6-10

Confocal Raman microscope system (LabRAM; Horiba, Inc.) was used for all spectroscopic studies. The excitation laser wavelength was 785 nm. For all protein samples, Raman spectral acquisitions were taken from a ten microliter drop of protein solution deposited on a gold-coated glass slide (Ted Pella No 26002-G). A thin layer of gold on a glass slide served three purposes: (i) to dissipate thermal energy due to the optical absorption of the excitation laser, (ii) to block the fluorescent and Raman background signals from the glass substrate, and (iii) to reflect the forward scattered Raman signal towards the detector. The laser was focused to an approximately one-micron spot size (FWHM) inside the liquid samples using a 100× microscope objective lens with 0.75 NA. The acquisition time was 5 seconds, and the signal was averaged over 12 spectra. The laser power at the sample was 7 mW. The detailed experimental setup is described in greater details in examples 1-5. Raman measurements were conducted on concentrated peptide and amino acid solutions using a macro extension of the microscope. 0.5 mL of sample solution was placed in a 10 mm long quartz cuvette (Sterna Cells Inc., #18SQG-10). The quartz cuvette was placed inside a macro cuvette holder. This holder included a lens with a 40 mm focal length on a horizontal exit, along with a 10 mm by 10 mm cell holder and spherical black mirror was incorporated into the holder to achieve a multi-pass effect, enhancing the interaction of light with the sample (Horiba, MACRO-CH adapter). The acquisition time was 5 seconds, and signal was averaged over 12 spectra. The laser power at the sample was 30 mW.

The LabSpec 6 software was used to control the microscope, collect Raman spectra, and preprocess the spectra. Data preprocessing included 7th order polynomial background removal with 140 points, unit-vector normalization, and Savitsky-Golay smoothing with 20 adjacent points. OriginPro 2023 software was used for multiple linear fittings to estimate the amino acid compositions and secondary structures of protein samples.

### Example 6

### Raman Spectral Construction Process of a Peptide and Construction of Raman Spectra of Protein

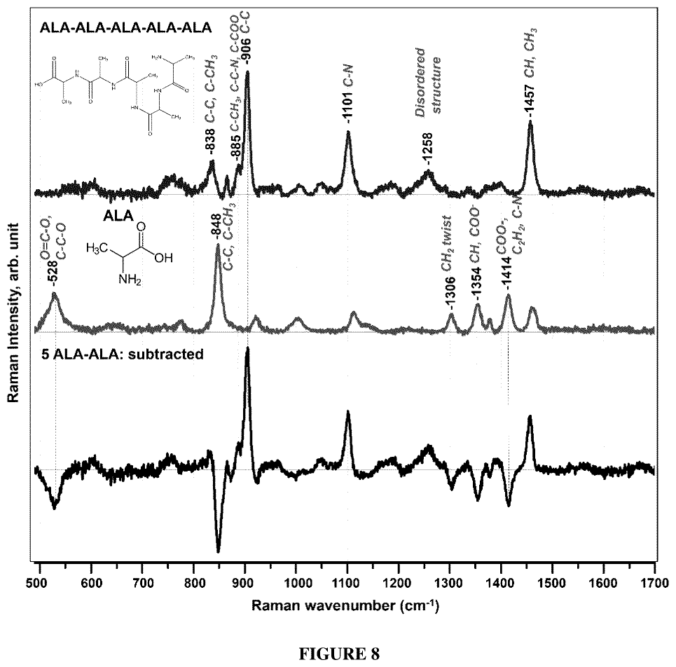

To illustrate how the Raman spectral construction process works, consider a peptide chain formed from a single type of amino acids, such as alanine. The top trace of FIG. 8 shows the spectrum of the peptide, which was penta-alanine including 5 identical amino acids.

The middle trace shows the pure amino acid alanine at the same molar concentration. Multiplying this spectrum by 5 and subtracting from the penta-alanine spectrum gives the difference spectrum in the bottom trace. This is the first spectral analysis of a peptide including the Raman spectra of its constituent amino acids. On one hand, the alanine spectrum (depicted by the red curve) exhibits vibrational modes related to its amine and carboxyl ends, exemplified by peaks at 528, 848, 1354, and 1414 cm⁻¹. On the other hand, these modes are notably absent in the measured spectrum of penta-alanine (illustrated by the blue curve). It is rational to infer that the amine and carboxyl ends are no longer free to produce vibrational modes in the penta-alanine structure.

Consequently, the difference spectrum (represented by the black curve) displays negative peaks, indicating the absence of bands observed in some carboxyl and amine groups of the original amino acids for the measured spectra. Simultaneously, positive peaks in this difference spectrum highlight new bands that emerge when the amino acids combine to form the peptide. This comparative analysis provides valuable insights into the structural changes and interactions occurring as amino acids when joined to create the peptide.

To extend the spectral construction technique to complex proteins, the first step is to measure the Raman spectra of all 20 individual amino acids in aqueous solutions with equal concentrations. FIG. 8 shows the Raman spectra of the 20 amino acid solutions measured.

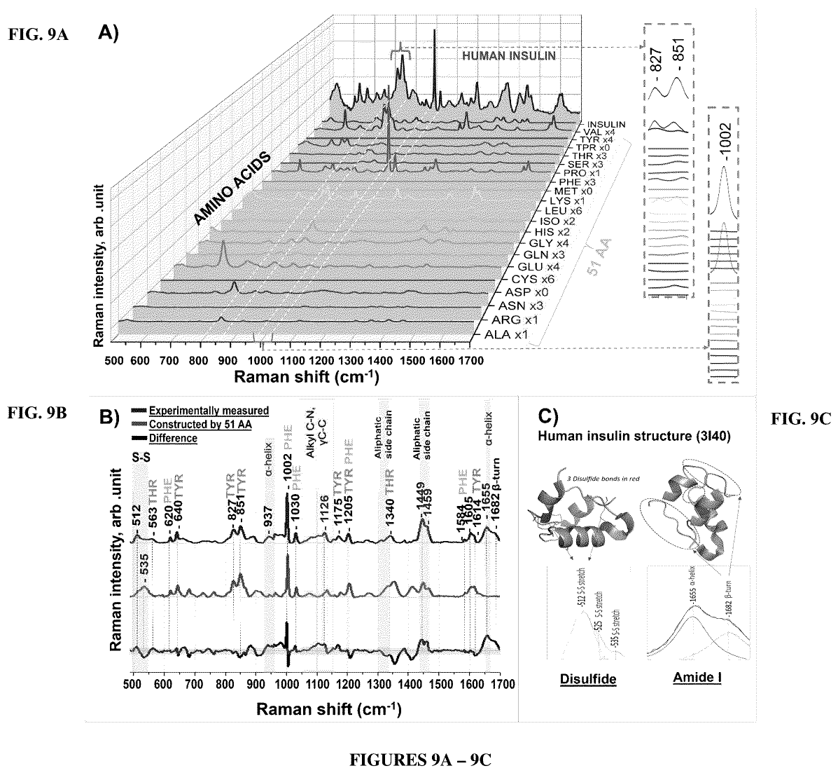

Previous Raman studies of amino acid solutions were limited in scope, and did not include each of the 20 amino acids. Next, the constructed spectrum of a relatively small protein, insulin with 51 amino acids, is created, as shown in FIG. 9A. This is done by first multiplying each amino acid spectrum by the number of times it occurs in insulin. Then, the resulting spectra are added to give the constructed insulin spectrum as shown in the last maroon trace (FIG. 9A). To visualize the relative contributions of the individual amino acids in insulin to the constructed spectrum more easily, FIG. 9A shows a 3D profile of the relative intensities of each Raman band for each amino acid (labelled rows), weighted by the number of occurrences of that amino acid in insulin. This map is useful to interpret the roles of various amino acids in each spectral region. It is worth noting that the spectra of the amino acids with a ring structure have larger Raman signatures than the others, and so the constructed spectrum will weigh these more heavily (FIG. 9A). As can be seen, there are spectral regions dominated by a single amino acid as well as regions with similar contributions from two or more amino acids. For example, the region between 820 cm⁻¹ and 865 cm⁻¹ was contributed from more than 2 amino acids versus the peak of 1002 cm⁻¹ which was contributed by one amino acid, phenylalanine (two zoomed spectral regions in FIG. 9A). The amino acids displayed common peaks attributed to the amine (NH₃⁺) and carboxylate (COO—) groups, as outlined in Table 2.

TABLE 2
Raman band assignments of amino acids and secondary structures of the protein.

| | Raman band | | | | |
|---|---|---|---|---|---|
| | assignments | 500 | 600 | 700 | 800 |
| Non- | deformation | 533-563 | | | |
| aromatic | O═C—O and | | | | |
| amino | C—C—O | | | | |
| acids | amide bending | | 623 | | |
| | CS/CH₂—S/ | | 639-698 | 720 | |
| | S—CH stretching | | | | |
| | COO— wagging | | 640-664 | | |
| | CH₂ | | | | |
| | twisting/rocking | | | | |
| | COO— bending | | | 770-805 | |
| | C—C skeletal | | | 752-778 | 832-897 |
| | stretch | | | | |
| | C—CH₃ | | | | 849-851 |
| | stretching | | | | |
| | C—C—N | | | | 822-871 |
| | stretching | | | | |
| | C—COO | | | | 870 |
| | stretching | | | | |
| | C—C stretching | | | | 895- |
| | C—COOH | | | | 895- |
| | stretching | | | | |
| | C—OH twisting | | | 731, 741 | |
| | CH₂ wagging | | | | |
| | CH deformation | | | | |
| | CH₃ rocking | | | 750-780 | |
| | CH₃ | | | | |
| | deformation | | | | |
| | COOH stretch | | | | |
| | CNH₃ stretch | | | | |
| | COO— sym. | | | | |
| | stretching, | | | | |
| | Cα₂H₂ | | | | |
| | deformation | | | | |
| | C—N, C—NH₂ | | | | |
| | stretching | | | | |
| | NH₂ scissoring | | | | |
| | and bending | | | | |

| | Raman band | | | | |
|---|---|---|---|---|---|
| | assignments | 900 | 1000 | 1100 | 1200 |
| Non- | deformation | | | | |
| aromatic | O═C—O and | | | | |
| amino | C—C—O | | | | |
| acids | amide bending | | | | |
| | CS/CH₂—S/ | | | | |
| | S—CH stretching | | | | |
| | COO— wagging | | | | |
| | CH₂ | | | 1172-1199 | 1294- |
| | twisting/rocking | | | | |
| | COO— bending | | | | |
| | C—C skeletal | 905-951 | 1030-1056 | 1120-1152 | |
| | stretch | | | | |
| | C—CH₃ | 905 | | | |
| | stretching | | | | |
| | C—C—N | 920-947 | | | |
| | stretching | | | | |
| | C—COO | 920-950 | | | |
| | stretching | | | | |
| | C—C stretching | −951 | 1006, 1072 | 1130 | |
| | C—COOH | −922 | | | |
| | stretching | | | | |
| | C—OH twisting | | | | |
| | CH₂ wagging | 986, 992 | 1030-1034 | | |
| | CH deformation | | | | |
| | CH₃ rocking | | | | |
| | CH₃ | | | | |
| | deformation | | | | |
| | COOH stretch | | | | |
| | CNH₃ stretch | | | | |
| | COO— sym. | | | | |
| | stretching, | | | | |
| | Cα₂H₂ | | | | |
| | deformation | | | | |
| | C—N, C—NH₂ | | 1067- | −1112 | |
| | stretching | | | | |
| | NH₂ scissoring | | | | |
| | and bending | | | | |

| | Raman band | | | | |
|---|---|---|---|---|---|
| | assignments | 1300 | 1400 | 1500 | 1600 |
| Non- | deformation | | | | |
| aromatic | O═C—O and | | | | |
| amino | C—C—O | | | | |
| acids | amide bending | | | | |
| | CS/CH₂—S/ | | | | |
| | S—CH stretching | | | | |
| | COO— wagging | | | | |
| | CH₂ | −1311 | | | |
| | twisting/rocking | | | | |
| | COO— bending | | | | |
| | C—C skeletal | | | | |
| | stretch | | | | |
| | C—CH₃ | | | | |
| | stretching | | | | |
| | C—C—N | | | | |
| | stretching | | | | |
| | C—COO | | | | |
| | stretching | | | | |
| | C—C stretching | | | | |
| | C—COOH | | | | |
| | stretching | | | | |
| | C—OH twisting | | | | |
| | CH₂ wagging | | | | |
| | CH deformation | 1320-1358 | 1446-1479 | | |
| | CH₃ rocking | 1327-1358 | | | |
| | CH₃ | 1354-1373 | 1446-1479 | | |
| | deformation | | | | |
| | COOH stretch | 1371 | 1418 | 1583-1597 | 1613 |
| | CNH₃ stretch | 1396-1398 | | | |
| | COO— sym. | 1320-1358 | 1396-1425 | | |
| | stretching, | | | | |
| | Cα₂H₂ | 1371- | 1418 | | |
| | deformation | | | | |
| | C—N, C—NH₂ | 1409- | 1418 | | |
| | stretching | | | | |
| | NH₂ scissoring | | | 1583-1622 | 1632-1643 |
| | and bending | | | | |

| | Raman band | | | | |
|---|---|---|---|---|---|
| | assignments | 500 | 600 | 700 | 800 |
| ring deformation | | 620 ± 3 | | | |
| para- substituted | | 642 ± 3 | | | |
| benzene | | | | | |
| Pyrrole ring in | | | 755 ± 3 | | |
| phase breathing | | | | | |
| Tyrosine | | | | 829 ± 3, | |
| doublet/phenol | | | | 847 ± 3 | |
| ring breathing | | | | | |
| symmetric ring | | | | 843 ± 3 | |
| stretching | | | | | |
| N—H bending, | | | | 837 ± 3 | |
| indole ring | | | | | |
| vibration | | | | | |
| symmetric ring | | | | | |
| breathing/stretching | | | | | |
| Pyrrole out of | | | | | |
| phase breathing | | | | | |
| Tryptophan's | | | | | |
| doublet | | | | | |
| Ring stretching | | | | | |
| Ring stretch | | | | | |
| doublet | | | | | |
| Ring | | | | | |
| vibration/stretch | | | | | |
| C—C stretching on | | | | | |
| pyrrole ring | | | | | |
| C₆H₅—C vibration | | | | | |
| phenol ring | | | | | |
| breathing | | | | | |
| α-helix | | | | | |
| β-sheet | | | | | |
| Disordered | | | | | |
| Aliphatic side chain | | | | 890- | |
| Alkyl C—N, | | | | | |
| skeletal γC—C | | | | | |
| disulfide | 500-565 | | | | 500-565 |

| | Raman band | | | | |
|---|---|---|---|---|---|
| | assignments | 900 | 1000 | 1100 | 1200 |
| ring deformation | | | | | |
| para- substituted | | | | | |
| benzene | | | | | |
| Pyrrole ring in | | | | | |
| phase breathing | | | | | |
| Tyrosine | | | | | |
| doublet/phenol ring | | | | | |
| breathing | | | | | |
| symmetric ring | | | | | |
| stretching | | | | | |
| N—H bending, | | | | | |
| indole ring | | | | | |
| vibration | | | | | |
| symmetric ring | | | 1002 ± 3 | | |
| breathing/stretching | | | | | |
| Pyrrole out of | | | 1008 ± 3 | | |
| phase breathing | | | | | |
| Tryptophan's | | | | | |
| doublet | | | | | |
| Ring stretching | | | | | |
| Ring stretch | | | | | |
| doublet | | | | | |
| Ring | | | | | |
| vibration/stretch | | | | | |
| C—C stretching on | | | | | |
| pyrrole ring | | | | | |
| C₆H₅—C vibration | | | | | 1201 ± 3 |
| phenol ring | | | | | 1205 ± 3 |
| breathing | | | | | |
| α-helix | | 930-950 | | | 1270-1300 |
| β-sheet | | | | | 1235-1250 |
| Disordered | | | | | 1250-1270 |
| Aliphatic side chain | | −920 | | | |
| Alkyl C—N, | | | 1050- | −1170 | |
| skeletal γC—C | | | | | |
| disulfide | | | | | |

| | Raman band | | | | |
|---|---|---|---|---|---|
| | assignments | 1300 | 1400 | 1500 | 1600 |
| ring deformation | | | | | |
| para- substituted | | | | | |
| benzene | | | | | |
| Pyrrole ring in | | | | | |
| phase breathing | | | | | |
| Tyrosine | | | | | |
| doublet/phenol ring | | | | | |
| breathing | | | | | |
| symmetric ring | | | | | |
| stretching | | | | | |
| N—H bending, | | | | | |
| indole ring | | | | | |
| vibration | | | | | |
| symmetric ring | | | | | |
| breathing/stretching | | | | | |
| Pyrrole out of | | | | | |
| phase breathing | | | | | |
| Tryptophan's | | 1339/1357 | | | |
| doublet | | | | | |
| Ring stretching | | 1365 ± 3 | | | |
| Ring stretch | | | | 1585 ± 3 | 1605 ± 3 |
| doublet | | | | | |
| Ring | | | | | 1615-1618 |
| vibration/stretch | | | | | |
| C—C stretching on | | | | 1557 | |
| pyrrole ring | | | | | |
| C₆H₅—C vibration | | | | | |
| phenol ring | | | | | |
| breathing | | | | | |
| α-helix | | | | | 1650-1655 |
| β-sheet | | | | 1550-1555 | 1665-1680 |
| Disordered | | | | | |
| Aliphatic side chain | | 1300-1340 | 1449-1459 | | |
| Alkyl C—N, | | | | | |
| skeletal γC—C | | | | | |
| disulfide | | | | | |

Table 2 delineates the predominant spectral positions of the vibrational modes corresponding to specific chemical bonds. Notably, bands associated with the deformation of O═C—O and C—C—O were identified in the range of 532-563 cm⁻¹, with COO— wagging peaks observed between 640-664 cm⁻¹. CC skeletal stretching vibrational modes were prevalent across amino acid spectra, spanning 445-458, 752-778, 832-853, 862-897, 909-951, 1030-1056, and 1120-1152 cm⁻¹. CN stretches and C—NH₂ stretching modes manifested bands from 1067-1112 cm⁻¹. Additionally, peaks attributed to CH₂ twist and rock were observed within the range of 1172-1199 cm⁻¹ and 1294-1311 cm⁻¹. Symmetrical stretches of COO-were evident in bands spanning 1320-1358 cm⁻¹ and 1396-1425 cm⁻¹, while CH and CH₃ deformations were observed in the ranges of 1320-1358 cm⁻¹ and 1446-1479 cm⁻¹. Bands associated with amine (NH₂ scissoring and bending) were identified in the regions of 1583-1622 cm⁻¹ and 1632-1643 cm⁻¹.

Furthermore, comparison of this constructed spectrum of insulin with the actual measured spectra, where the measured Raman spectrum of human insulin is shown in the top trace (blue) of FIG. 9B. The middle trace (red) is the constructed spectrum from FIG. 9A duplicated for convenience. The bottom trace of FIG. 9B is the difference spectrum between the measured and the constructed spectra. The correlation coefficient (Corr-R2) between the constructed and measured spectra calculated for insulin was 0.65. That means the constructed spectra presented 65% of the actual spectra of insulin. The difference spectra between them had negative and positive regions and peaks similar to the difference spectra between the penta-alanine and the alanine in FIG. 8. Again, positive peaks in the difference spectra identify new bands that form when the individual amino acids combine to make the insulin. The positive peaks around 1450 cm⁻¹ and 1655 cm⁻¹ correspond to the secondary structure of insulin including, an aliphatic side chain and a-helix, respectively. Whereas negative peaks show bands around 535, 848, 910, 1360, and 1414 cm⁻¹ wavenumbers corresponded to the vibrational modes of carboxyl, amine groups, and the C—C skeletal stretching of amino acids that disappeared due to peptide bonding. To illustrate how the measured spectrum can be interpreted in light of the known protein structure, FIG. 9C highlights the amide I (a-helix and B-sheet) and disulfide regions. In each case, the structure is shown from a convenient viewpoint and the spectral features are deconvolved to show the weighting of specific bonds. The amide I regions are the same in the measured and the difference spectra, whereas the disulfide regions were very different in these spectra (FIG. 9C).

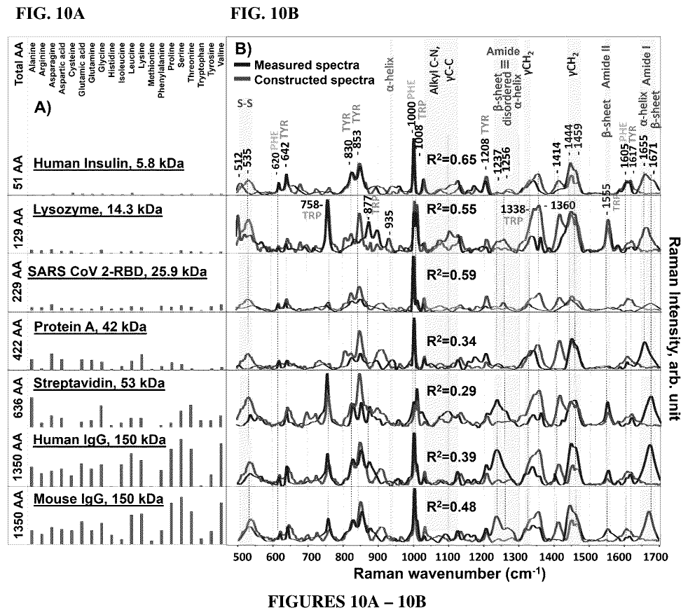

Further illustrating the power of this construction technique, a larger number of larger proteins was analyzed. To get a feel for the relative size of the experimental proteins, FIG. 10A shows their amino acid frequencies as histograms, molecular weights (kDa), and the total numbers of their amino acid (Total AA).

The histograms show the amino acid distributions of the proteins, and clearly illustrates the large difference in complexity where insulin shows the less compared to the two antibodies. FIG. 10B depicts the constructed Raman spectra (red) superimposed on the experimentally measured spectra (blue) for the experimental proteins. For the sake of consistency, all Raman spectra were normalized. The correlation coefficients (Corr-R2) between the constructed and measured spectra were calculated and are displayed in FIG. 10B.

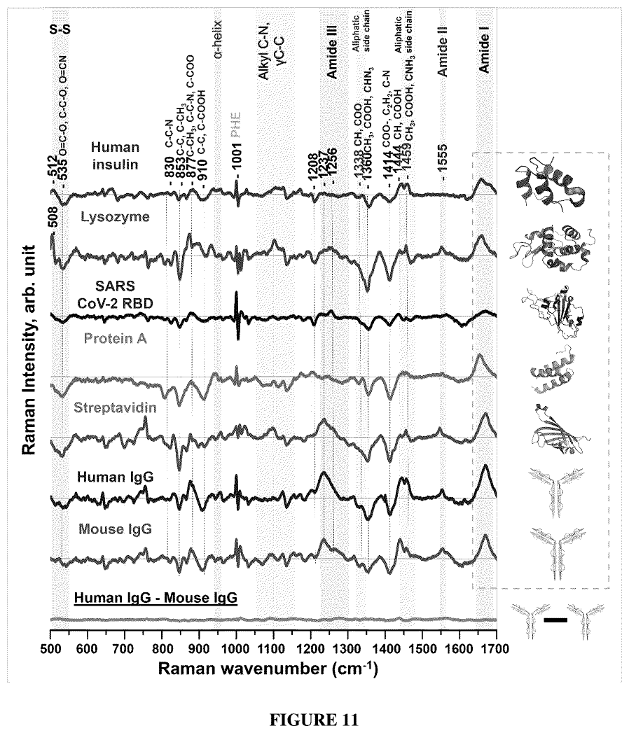

Furthermore, the difference spectra between the measured and constructed Raman spectra for each protein were calculated and are shown in FIG. 11. To illustrate that these difference spectra are not simply noise, the bottom trace (grey) shows a difference of differences for the two antibodies. Although these antibodies are from different species, they have many structural similarities and hence the difference of differences more closely resembles one of the smaller, less complex proteins. One can see that all difference spectra have similar negative peaks as observed in the difference spectra of the penta-alanine spectra as shown in FIG. 8 and the human insulin as shown in FIG. 9B. Again, same negative peaks were observed around 535, 848, 910, 1360, and 1414 cm⁻¹ indicative of the amine and carboxyl groups of the amino acids which disappeared during formation of peptide chain. The positive peaks evident in the difference Raman spectra correlate with the secondary structure inherent in the proteins. However, the presence of strong negative peptide bonding in FIG. 11 obscured the representation of disulfide bonding between 515 and 550 cm cm⁻¹. Additionally, it was observed that the proteins' Amide III modes within the 1230 to 1300 cm⁻¹ range which exhibited a minimal presence in smaller proteins maintained a pronounced presence in larger proteins. Fortunately, uniformity was maintained in the Amide I mode spanning 1627 to 1700 cm cm⁻¹ across all protein samples shown in the difference spectra. Importantly, this spectral region was devoid of any discernible vibrational modes associated with amino acids or peptide bonding, establishing it as a dependable source of information concerning the proteins' secondary structures. Consequently, this spectral region was employed for the assessment of protein sample secondary structures.

### Example 7

### Laser Induced Heating Process in Protein Solution

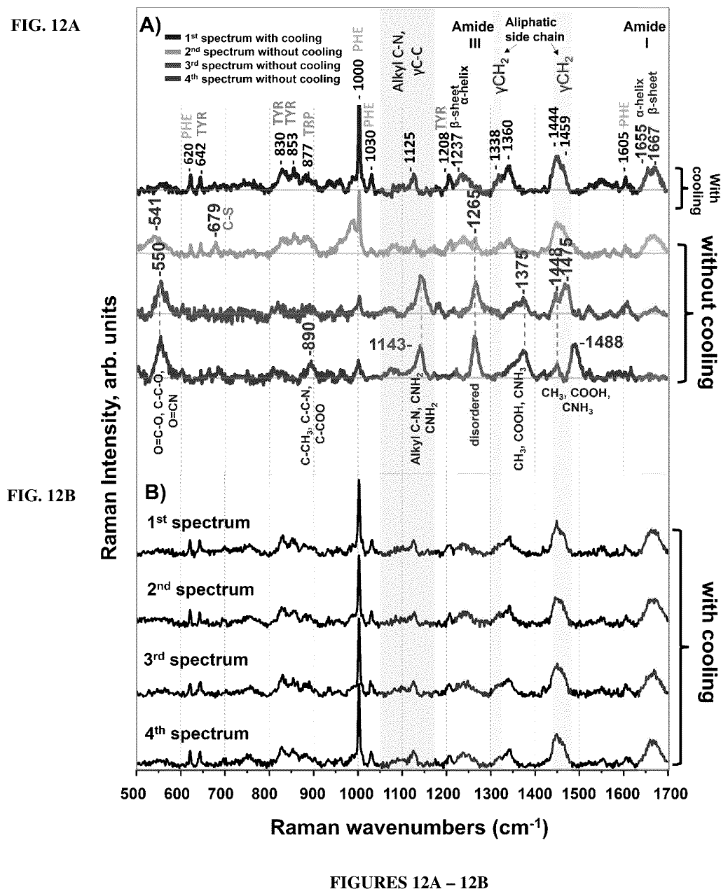

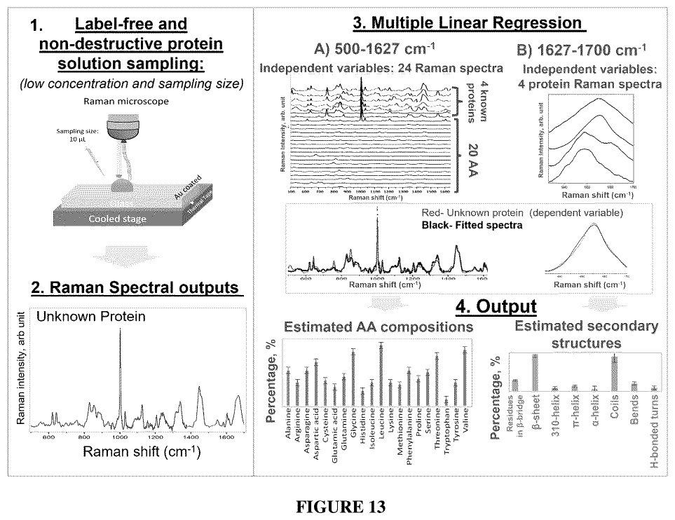

The experimental investigation involved subjecting the cooled and uncooled protein samples to heating from the excitation laser, resulting in noteworthy transformations of the Raman spectra. The laser-generated heat led to substantial changes in the molecular structure of the protein, as evidenced by several key observations (FIG. 12A).

Firstly, the Raman spectra revealed the emergence of new peaks, including those at 541, 679, and 1265 cm⁻¹, each linked to distinct molecular vibrational modes within the uncooled protein sample (orange curve in FIG. 12A). For instance, the peaks at 541 cm⁻¹ are associated with carboxyl and amine groups of amino acids, while the 679 cm⁻¹ peak pertains to the C—S stretching mode of cysteine and methionine. These findings suggested that specific amino acids were released from peptide bonds due to the heating. Moreover, the appearance of the Amide III peak at 1265 cm⁻¹ pointed to a disrupted secondary structure within the sample. With continued excitation laser heating (the red curve in FIG. 12A), the peaks corresponding to phenylalanine, tyrosine, and tryptophan diminished, accompanied by alterations in aliphatic side chain modes. Broad modes related to carboxyl/amino groups emerged at 1143 and 1375 cm⁻¹. As the heating persisted (the maroon curve in FIG. 12A), the Amide I mode vanished, while the Amide III mode associated with disordered structures became more prominent, collectively suggesting complete thermal decomposition of the protein's secondary structure and the consequent rupture of peptide bonds between amino acids due to the laser-induced heating. In FIG. 12B, the consecutive spectra of the same protein sample obtained under controlled cooling conditions exhibited a consistent lack of change over the successive measurements.

### Example 8

### Estimated Amino Acid Composition and Secondary Structures of Proteins

Finally, an exploration to determine if the inverse application of the construction technique previously showcased (depicted as the blue path in FIG. 7) could be leveraged to provide an initial estimation of the amino acid composition and secondary structures of unknown proteins. Just as fragments offer insights into the larger molecular structure, the measured Raman spectra was sought to glean information about the amino acid compositions and secondary structure of a given unknown protein. This novel approach aimed to bridge the gap between Raman spectroscopy and protein analysis, potentially unlocking new possibilities for understanding protein structures and compositions.

To ascertain the precision of the technique, an evaluation using measured Raman spectra from three distinct protein samples including the main protease of SARS CoV-2 (M^{pro}), transthyretin, and human IgG CR3022. Subsequently, comparison of the actual quantities of each amino acid and the secondary structures present in these proteins with the estimated percentages was derived from the application of TRIP.

By subjecting these two sets of data (the real proportions of amino acids and secondary structures versus the estimations provided by the technique) to a comparative analysis, the accuracy and reliability of the method was gauged. This validation process served to affirm the technique's effectiveness in capturing and reflecting the true composition and structural characteristics of the proteins under examination. In doing so, the credibility of the technique as a viable tool for protein analysis and structural elucidation vsn be established.

In the TRIP technique in conjunction with MLR the estimation of both the amino acid composition and secondary structures of these three proteins was obtained. The spectral regions were partitioned into two segments: one spanning from 500 to 1627 cm⁻¹ for amino acid estimation, and another from 1627 to 1700 cm⁻¹ for secondary structure estimation.

Through adapting the TRIP technique and employing MLR in this manner, approximating the amino acid composition and secondary structures of proteins whose characteristics were previously unknown was possible.

### Example 9

### Estimating Amino Acid Compositions: 500-1627 cm⁻¹ Spectral Region

Multiple linear regression (MLR) is a powerful tool that enables predictions to be made concerning a specific variable (referred to as the dependent variable) using information that is available about another variable (known as the independent variable). MLR is a statistical technique employed to examine the correlation between one dependent variable and two or more independent variables. Unlike simple linear regression, which analyzes the relationship between a single independent variable and a dependent variable, multiple linear regression integrates multiple predictors. The primary aim of multiple linear regression is to construct a linear model that accurately forecasts the values of the dependent variable by considering the values of the independent variables. The model operates under the assumption of a linear association between the independent variables and the dependent variable.

MLR, as a representative example of multivariate statistical methods, which finds widespread use in spectral analysis, notably in techniques like Near Infrared Spectroscopy and Raman spectroscopy. In these analytical contexts, MLR serves as a robust framework for uncovering patterns and relationships within complex spectral data, ultimately leading to valuable insights and predictions.

Initially, a strategy was employed where the Raman spectra of 20 distinct amino acids served as independent variables for MLR. The objective was to predict the spectra of the M^{pro} with the dependent variable being its spectra. However, the coefficient of determination (R2) achieved was 0.29, indicating that merely 29% of the variability in the unknown spectra could be accounted for using the spectra of the 20 amino acids, likely because essential components like secondary structure and peptide formation bands were absent in the individual amino acid spectra.

To enhance the predictive capacity, the spectra of two proteins, insulin and lysozyme, characterized by α-helix dominance, as well as the spectra of two proteins, SARS-CoV-2 RBD (RBD) and streptavidin, which are characterized by B-sheet prevalence, were integrated into the MLR as independent variables. This expanded the independent variable set to 24. As a result of this augmentation, the R2 value for the M^{pro} spectra improved to 0.86. This enhancement demonstrates the contribution of these additional spectral profiles in capturing the underlying patterns in this protein's spectra.

Moreover, the analysis utilizing MLR revealed an intriguing pattern: a subset comprising just 10 independent variables was identified as being influential in capturing the Raman spectra of the M^{pro}, while this subset was slightly less compact for the other two proteins, comprising 8-7 independent variables.

Of notice, the composition of the M^{pro} influential set was more diverse. It encompassed 6 specific amino acids-glycine, isoleucine, lysine, methionine, phenylalanine and proline-alongside 4 proteins-RBD, lysozyme, insulin, and streptavidin. In contrast, the M^{pro}, transthyretin's influential set including 5 amino acids—isoleucine, leucine, lysine, phenylalanine, and proline—paired with 3 proteins, lysozyme, insulin and streptavidin. Similarly, the human IgG's influential set comprised 4 amino acids—isoleucine, leucine, proline and tyrosine—with 3 proteins—RBD, insulin, and streptavidin.

These findings underscore the role played by these specific components in accurately representing the spectral characteristics of each protein. The selection of specific amino acids and proteins within these subsets attests to their impact on shaping the intricate spectral profiles of the proteins under investigation.

Next, the estimated percentages of each amino acids based on MLR results was calculated. The linear function of the MLR is given by equation 1:

$${Y}_{unknown} = {\sum }_{i = 1}^{i = 24} {a}_{i} {Y}_{i} \qquad ( 1 )$$

Here aᵢ>0, Σ₁²⁴ aᵢ=1, are the slope coefficients, and Y_{unknown} denotes the fitted Raman spectra of unknown protein and Yᵢ denotes the Raman spectra of the 20 amino acids and 4 known proteins.

The outcomes of the multiple linear regression yielded slope coefficients (aᵢ) assigned to each independent variable. Given that these coefficients summed to 1, multiplying them by 100 facilitated the derivation of percentages for each independent variable. These percentages, of the known proteins, were then dissected into the constituent amino acids, leveraging their amino acid compositions.

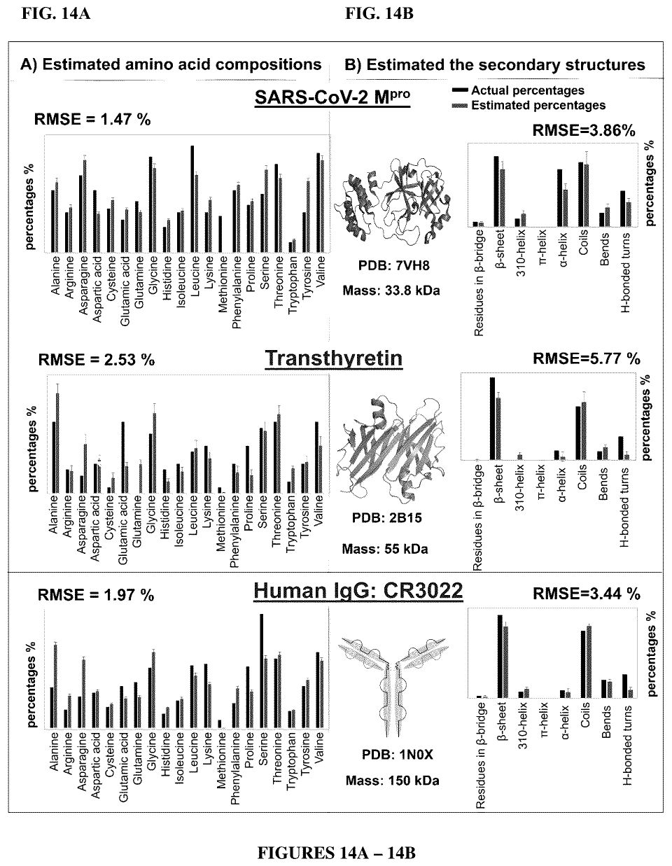

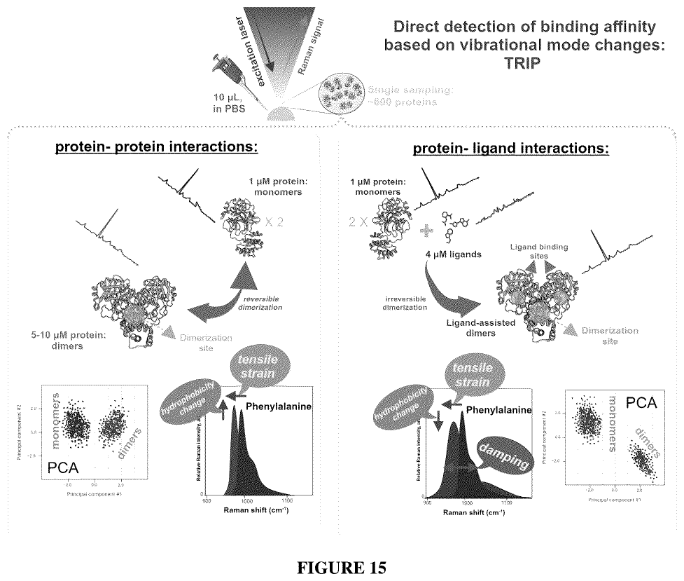

To arrive at the ultimate proportion of each amino acid, a comprehensive calculation from the percentages obtained from the four known proteins with those stemming from the MLR. This computational procedure was executed for three proteins: M^{pro}, transthyretin, and human IgG. In FIG. 14A, a visual comparison of the projected percentages of the 20 amino acids against the actual quantities present is shown.

Then the RMSE for the estimated amino acid frequencies using the following equation 2 was calculated.

$$R M S E ( \% ) = \sqrt{\frac{{\sum }_{i = 1}^{i = 20} {( {estimated}_{i} - {actual}_{i} )}^{2}}{20}} \qquad ( 2 )$$

Here i is the assigned numbers for each amino acid. For example, the number 1 is for Alanine, . . . , and the number 20 is for Valine as used in same order as in FIG. 14A.

Through the above calculation, the RMSE was determined for the estimated amino acid compositions of M^{pro}, transthyretin, and a human IgG. The resulting RMSE values were computed as 1.47%, 2.53%, and 1.97% respectively.

This systematic approach harmonized MLR-derived coefficients with known amino acid compositions, leading to accurate estimations of amino acid percentages for the unknown proteins. The RMSE values validated the precision of these estimations in reflecting the actual amino acid makeup of the proteins.

### Example 10

### Estimating Secondary Structures: 1627-1700 cm⁻¹ Spectral Region

In this particular region of investigation, four proteins-insulin, lysozyme, RBD, and streptavidin-were initially chosen as independent variables that were used in the previous study involving MLR. However, the errors of the fitting coefficients resulting from this initial approach were very high, up to 50%. Therefore, subsequently, different protein combinations of 3 and 2 as independent variables were tried. Two proteins, lysozyme and streptavidin, resulted in the least amount of error in the fitting coefficients in relation to three proteins being studied.

An aspect of this study revolved around scrutinizing the composition of secondary structures, including α-helices, β-sheets, residues in β-bridges, 310-helices, π-helices, coils (CCcoilTT), bends, and H-bonded turns within the proteins. These findings are visualized in FIG. 14B, allowing for a meaningful comparative assessment between projected and actual percentages of protein secondary structure.

In addition, the study employed the concept of RMSE as a metric to gauge prediction accuracy using the equation 3:

$$R M S E ( \% ) = \sqrt{\frac{{\sum }_{i = 1}^{i = 8} {( {estimated}_{i} - {actual}_{i} )}^{2}}{8}} \qquad ( 3 )$$

Here i is the assigned numbers for each secondary structure. For example, the number 1 is for α-helix, the number 2 for β-sheet, the number 3 for residues in a β-bridge, the number 4 for a 310-helix, the number 5 for a π-helix, the number 6 for a coils, the number 7 for a bends, and the number 8 for H-bonded turns.

Through this RMSE analysis, the estimated percentages of secondary structures for three specific proteins-M^{pro}, transthyretin, and a human IgG-were subjected to evaluation, culminating in RMSE values of 3.68%, 5.77%, and 3.44%, respectively. This further attested to the study's efficacy in generating accurate structural predictions for given proteins.

### Example 11

### Exemplary Experimental Procedures for Examples 12-14

### Sample Preparation for Examples 12-14

The instant example provides exemplary materials and methods utilized in Examples 12-14 as described herein.

The expression and purification of SARS CoV-2 M^{pro} were conducted according to published procedure. MPI8 was synthesized according to previous report. The synthesis of VB-B-145, is described below. Halicin and Nirmatrelvir were purchased without further purification. M^{pro}'s original concentration was 8.9 mg/ml and was diluted to 1, 5, 10 μM in PBS for this study. The Halicin and VB-B-145 solutions were 50 mM in dimethyl sulfoxide (DMSO). The Nirmatrelvir and MPI8 solutions were supplied at 10 mM in DMSO. These solutions were further diluted to 20 μM and 4 μM in PBS.

Determination of Dissociation Constant (Kd) at Variable Temperatures by Native Mass Spectrometry (nMS)

M^{pro} was buffer-exchanged to 200 mM ammonium acetate (pH=6.8) by using Micro Biospin P-6 gel column (BioRad) for mass spectrometry analysis. Native mass spectrometry (nMS) analysis was performed on a Q Exactive UHMR Hybrid Quadruple-Orbitrap Mass Spectrometer (ThermoFisher) with m/z range set from 1,000 to 10,000. 10 μL sample was loaded to a borosilicate glass capillary tip (Sutter, CA) with 1100 to 1500 V spray voltage supplied by an inserted platinum wire. Activation energies were carefully optimized to remove non-specific adducts with minimal gas-phase activation. Those parameters include capillary temperature at 100° C., in-source trapping and activation at −10 V, ion transfer set to high m/z, collision-induced dissociation (CID) 10 eV, and higher energy dissociation (HCD) at 30 V. In the variable-temperature electrospray ionization (vT-ESI) experiment, the temperature of the solution was controlled at 4° C. or 25° C. and the time for equilibrium at each temperature was 5 minutes. The relative abundance of monomeric M^{pro} and dimeric M^{pro} were determined by deconvoluting the mass spectra with UniDec. The relative abundance was converted into concentration and subsequently used to yield the dissociation constant (Kd) as described in previous studies.

### Apparatus and Software as Used in Examples 12-14

Confocal Raman microscope system (LabRAM; Horiba, Inc.) was used for all spectroscopic studies. The excitation laser wavelength was 785 nm. For all protein samples, Raman spectral acquisitions were taken from a ten microliter drop of protein solution deposited on a gold-coated glass slide (Ted Pella No 26002-G). A thin layer of gold on a glass slide served three purposes: (i) to dissipate thermal energy due to the optical absorption of the excitation laser, (ii) to block the fluorescent and Raman background signals from the glass substrate, and (iii) to reflect the forward scattered Raman signal towards the detector. The laser was focused to an approximately one-micron spot size (FWHM) inside the liquid samples using a 100× microscope objective lens with 0.75 NA. That means each sampling volume approximately contained about 660 M^{pro} proteins for the 1 μM M^{pro} concentration to ensure statistical significance of the TRIP measurements.

The acquisition time was 5 seconds, and the signal was averaged over 12 spectra. The laser power at the sample was 7 mW. The detailed experimental setup is described in greater detail in previous examples. The cooled stage was kept at 12° C. on the gold substrate for all experiments.

The LabSpec 6 software was used to control the microscope, collect Raman spectra, and preprocess the spectra. Data preprocessing included 7^{th} order polynomial background removal with 140 points, unit-vector normalization, and Savitsky-Golay smoothing with 20 adjacent points. Aspen Unscrambler software was used for PCA analysis of Raman spectra of the experimental samples.

### Synthesis of VB-B-145

### Synthesis and NMR Assignments of VB-B-145 intermediate Methyl 2-(3-chlorophenyl)-3-(1,3-dioxoisoindolin-2-yl) propanoate (3)

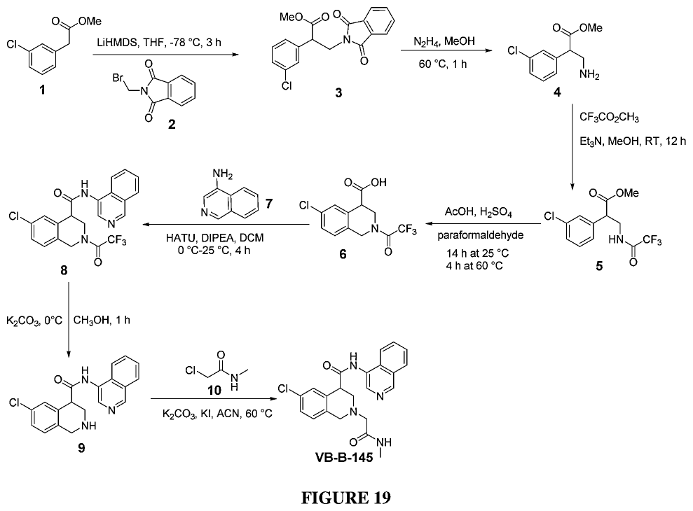

To synthesize a VB-B-145 intermediate, as shown as a visual representation in FIG. 19, methyl 2-(3-chlorophenyl)-3-(1,3-dioxoisoindolin-2-yl) propanoate (3), first add a solution of 1 (2.0 g, 10.8 mmol) to a solution of LiHMDS (1M in THF, 13 mL, 1.2 eq.,) at −78° C. in THF (16 mL) over 10 min. Stir the resulting orange mixture for 1 h at −78° C. Add a solution of N-(bromomethyl) phthalimide (1.2 eq.) in THF (16 mL) dropwise over 10 min. Stir the mixture 1 hour at −78° C. and then at 1 h at room temperature. Quench the yellow solution with 1N HCl (80 mL). Extract the solution with ethyl acetate. Wash the combined organic layers with water and dry over MgSO₄. Concentrate the organic layer. Purify the residue by column chromatography over silica gel (Hex/EA 1:1) to obtain 1.89 g of a white solid.

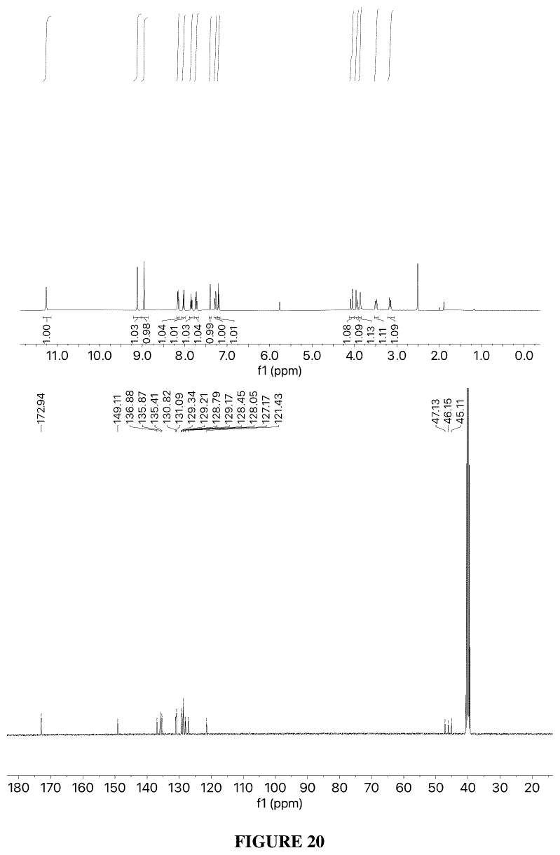

Assignment of the intermediate using NMR is as follows: ¹H NMR (400 MHz, DMSO) δ 7.85-7.78 (m, 4H), 7.36-7.34 (m, 1H), 7.33-7.29 (m, 2H), 7.27-7.21 (m, 1H), 4.24-4.10 (m, 2H), 4.02 (dd, J=13.7, 8.5 Hz, 1H), 3.60 (s, 3H). ^{13C} NMR (101 MHz, DMSO) δ 171.68, 167.83, 138.58, 135.07, 133.58, 131.64, 130.90, 128.69, 128.30, 127.57, 123.40, 52.83, 31.43, 22.53. The ¹H and ¹³C NMR are shown in FIG. 20.

### Synthesis and NMR assignments of VB-B-145 intermediate 6-chloro-N-(isoquinolin-4-yl)-1,2,3,4-tetrahydroisoquinoline-4-carboxamide (9)

To a suspension of intermediate 3 (1.5, 4.3 mmol) EtOH (10 mL) was added dropwise hydrazine monohydrate (1.1 mL, 5 eq.) at room temperature (rt). The mixture was stirred for 2 h at room temperature. The solvent was removed under reduced pressure and the colorless residue taken up in EA and citric acid 10%. The layers were separated, and the aqeuous phase was washed with EA. The organic layers were discarded. The product containing aqeuous phase was basified with NH₄OH and extracted twice with DCM. The combined DCM phases were dried over MgSO₄ and concentrated to afford a viscous liquid 4 (650 mg). Add triethylamine (1.5 eq.) and trifluoromethyl acetate (1.05 eq.) to a solution of amine 4 in THF. Stir the reaction at room temperature until completion of the reaction. Concentrate the reaction mixture under reduced pressure to obtain 5 which was used without further purification.

AcOH (0.23 M) and H₂SO₄ (0.35 M) were mixed at 0° C. before 5 (1 eq.) and paraformaldehyde (2 eq.) were added sequentially. The reaction mixture was stirred at room temperature overnight followed by stirring for 4 h at 60° C., then poured onto H2O. After extraction with EtOAc (3×45 mL), dried over Na₂SO₄, filtered and concentrated in vacuo. The crude trifluoroacetate protected 6 tetrahydro isoquinoline was used without further purification.

To this 6 and 7 were dissolved in dry DMF (20 mL) and the reaction was cooled to 0° C. HATU (1.5 eq.,) and DIPEA (3.0 eq.,) were added, and the reaction mixture was allowed warm up to room temperature and stirred for 12 h. The mixture was then poured into water (50 mL) and extracted with ethyl acetate (4×20 mL). saturated aqueous NaHCO₃ (2×20 mL), brine (2×20 mL) and dried over Na₂SO₄. The organic phase was evaporated to dryness and the crude trifluoroacetate protected 8 from the previous step was dissolved in MeOH (0.1 M) and an aqueous K₂CO₃ solution (0.44 M, 3 eq.) was added. The reaction mixture was stirred at 1 h 0° C. before being acidified to pH 8 with HCl (1 M). This mixture was extracted with EtOAc and the combined organic layers were washed with H₂O, dried over Na₂SO₄, filtered and concentrated in vacuo. the crude material purified by silica gel column chromatography (Hex/EA 2:8) to afford 9 as white solid (120 mg, 54%).

¹H NMR (400 MHZ, DMSO) δ 11.26 (s, 1H), 9.12 (s, 1H), 8.96 (s, 1H), 8.16 (d, J=8.2 Hz, 1H), 8.03 (dd, J=8.4, 1.2 Hz, 1H), 7.88-7.81 (m, 1H), 7.75-7.70 (m, 1H), 7.40 (d, J=2.2 Hz, 1H), 7.28 (dd, J=8.2, 2.3 Hz, 1H), 7.20 (d, J=8.3 Hz, 1H), 4.07 (d, J=16.3 Hz, 1H), 3.94 (d, J=16.4 Hz, 1H), 3.86 (t, J=4.0 Hz, 1H), 3.49 (dd, J=12.8, 3.5 Hz, 1H), 3.16 (dd, J=12.8, 4.5 Hz, 1H). ¹³C NMR (101 MHz, DMSO) δ 172.94, 149.11, 136.88, 135.87, 135.41, 131.09, 130.82, 129.34, 129.21, 129.17, 128.79, 128.45, 128.05, 127.17, 121.43, 47.13, 46.15, 45.11.

### Synthesis and NMR assignments of VB-B-145 intermediate 6-chloro-N-(isoquinolin-4-yl)-2-(2-(methylamino)-2-oxoethyl)-1,2,3,4-tetrahydroisoquinoline-4-carboxamide (VB-B-145)

To a solution of 9 (34 mg, 0.1 mmol) in acetonitrile (5 mL) were sequentially added potassium carbonate (14 mg, 0.1 mmol), KI (0.1 eq.,) and 10 (13.5 mg, 0.12 mmol). The reaction mixture was stirred at 60° C. for 4 h, then partitioned between EtOAc (20 mL) and water (15 mL). The organic layer was dried (MgSO₄) filtered and concentrated in vacuo. the crude material purified by silica gel column chromatography (DCM/MeOH 9:1) to afford VB-B-145 as white solid (25 mg).

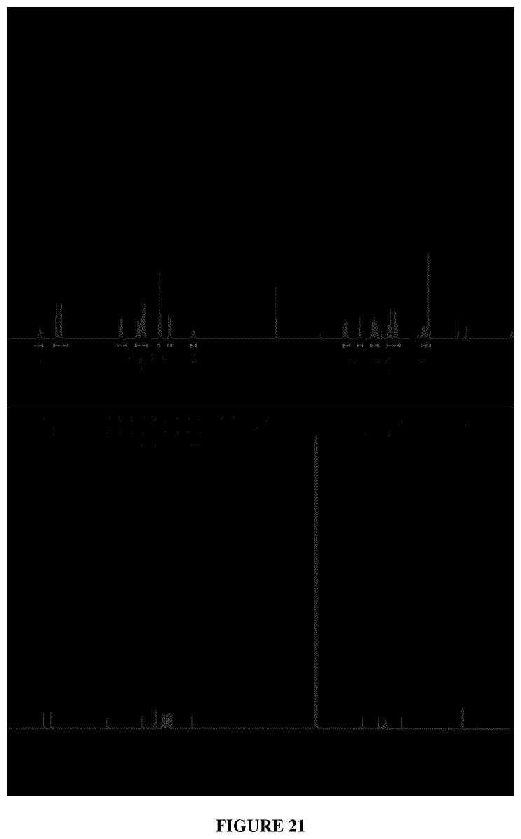

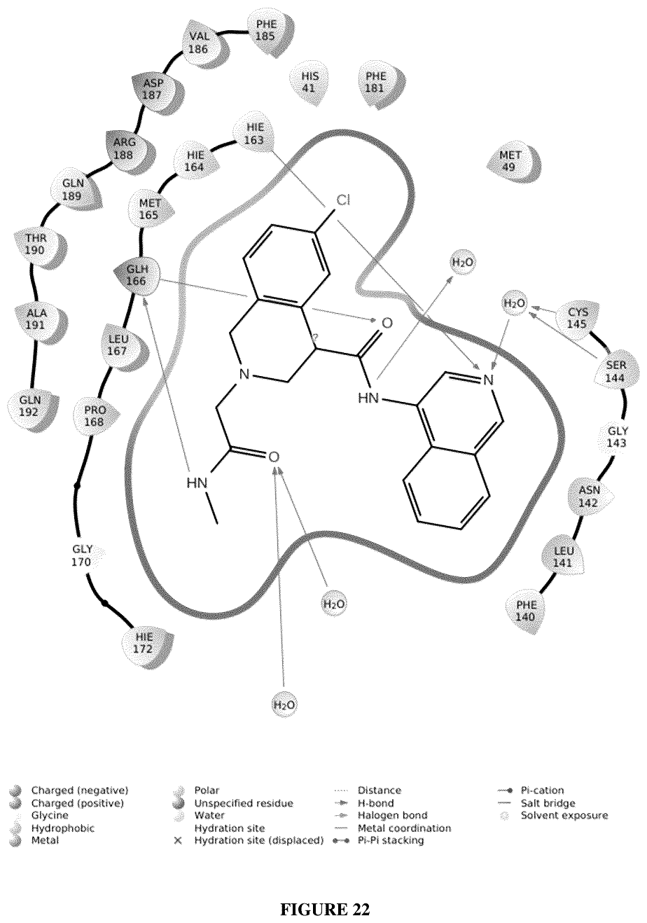

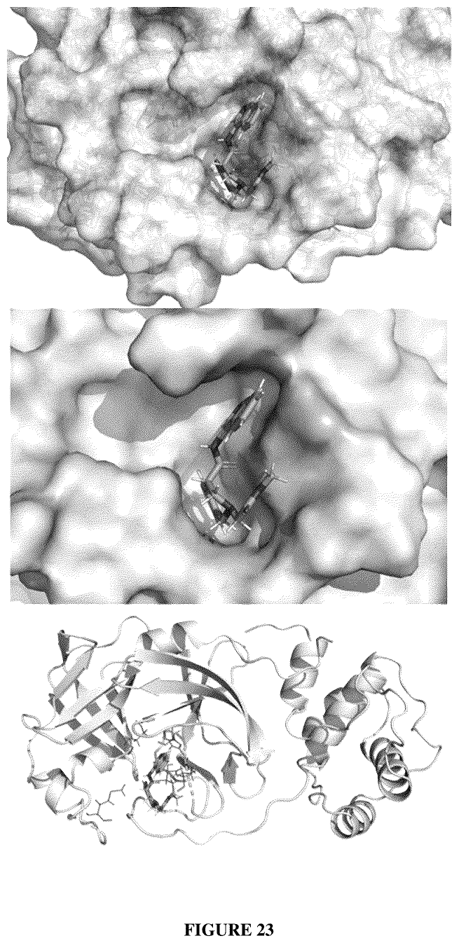

¹H NMR (400 MHZ, DMSO) δ 9.35 (d, J=7.7 Hz, 1H), 9.01 (d, J=29.9 Hz, 2H), 7.95 (d, J=8.1 Hz, 1H), 7.70-7.47 (m, 4H), 7.12 (d, J=8.4 Hz, 1H), 6.71 (s, 1H), 4.11 (dd, J=15.4, 4.0 Hz, 1H), 3.88 (t, J=2.8 Hz, 1H), 3.76-3.53 (m, 2H), 3.34 (s, 1H), 3.26 (d, J=15.7 Hz, 1H), 2.79 (dd, J=11.8, 3.7 Hz, 1H), 2.71 (s, 3H). ¹³C NMR (101 MHz, DMSO) δ 167.09, 164.72, 145.06, 132.94, 128.34, 128.24, 127.98, 125.93, 125.26, 124.33, 123.93, 123.82, 123.40, 123.32, 123.29, 122.63, 115.66, 56.11, 50.51, 48.02, 42.39, 21.23. The ¹H and ¹³C NMR are shown in FIG. 21.

### Example 12

### Screening of Reversible Protease Dimers

To determine the concentrations indicative of monomers or dimers in SARS-CoV-2 M^{pro} solution samples using mass spectrometry, a well-established method followed by subsequently, exploration of whether TRIP could differentiate between monomer and dimer M^{pro} samples.

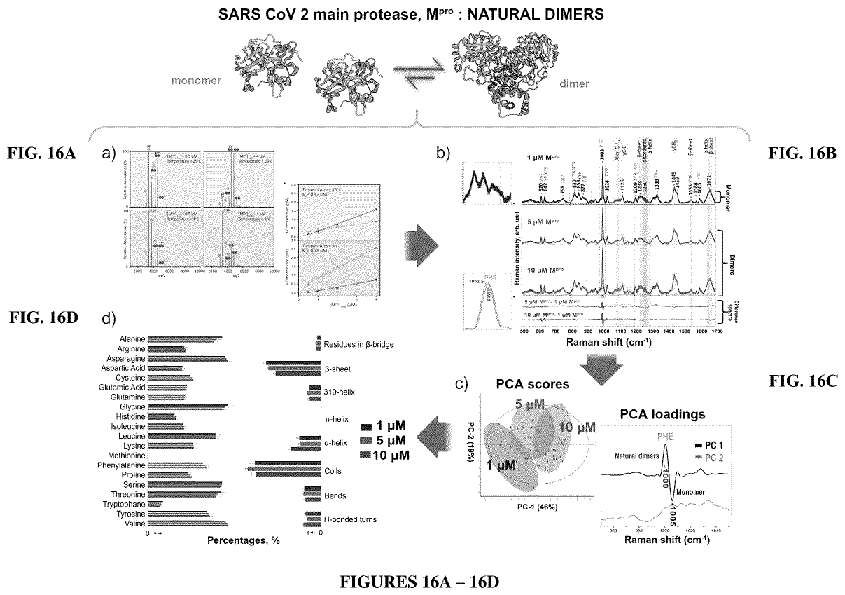

The investigation involved examining the dimer and monomer populations of SARS-CoV-2 M^{pro} at varying protein concentrations in solution, at temperatures of 4° C. and 25° C., using variable temperature electrospray ionization mass spectrometry (vT-ESI-MS), as illustrated in FIG. 16A.

FIG. 16A provides insights into the relative abundances of M^{pro} solutions at concentrations of 0.5 μM and 4 μM. When the 0.5 M M^{pro} solution was concentrated, it was predominantly composed of monomers at 4° C., and approximately 50% of these monomers persisted even at room temperature. Similarly, the 4 μM M^{pro} solution, when concentrated, exhibited a composition of more than 50% monomers at 4° C., with less than 20% remaining in the monomeric state at room temperature.

In FIG. 16A, it is seen that the dissociation coefficients (K_{D}) of the M^{pro} solutions were 8.78 μM at 4° C. and 0.47 μM at room temperature (25° C.), respectively. This observation underscores the substantial impact of temperature on the equilibrium between M^{pro} dimers and monomers in solution. Consequently, experimental solutions were maintained at a consistent temperature to mitigate any temperature-related effects.

### TRIP: Principal Component Analysis (PCA)

To assess the TRIP technique's ability to differentiate between M^{pro} monomers and dimers within solutions, three distinct concentrations: 1 μM, 5 μM, and 10 μM were investigated, with data insights from FIG. 16A, it was found that the 1 μM concentrated M^{pro} solutions predominantly included monomers, the 5 μM solutions contained a combination of monomers and dimers, and the 10 μM solution was primarily constituted of dimers, all which were maintained at a temperature of 12° C. Further employing the TRIP technique, measurements of the Raman spectra of M^{pro} at these three concentration levels were conducted as illustrated in FIG. 16B. Also generated are plots that depict the variance in the spectra (the difference spectra) between the 5 μM and 1 μM solutions, as well as between the 10 UM and 1 μM solutions, as seen in FIG. 16A. Notable intensity changes in the difference spectra occurred at phenylalanine's 1003 cm⁻¹ peak that corresponds to the breathing mode of its symmetric ring. Other changes in the difference spectra were within the errors of the original spectra.

Initially, PCA was employed to analyze the whole spectral region of Raman spectra of the experimental samples, but it didn't clearly separate the samples of different concentrations. Therefore, PCA analysis was applied for the spectral region between 950 and 1050 cm⁻¹, as illustrated in FIG. 16C. According to the PCA plot, the clusters corresponding to the 1 μM and 10 μM samples were distinct from each other, while the 5 μM samples overlapped with both the 1 μM and 10 μM sample clusters. This observation is consistent with 5 μM samples having a roughly equal proportion of monomers and dimers, whereas the 1 μM samples are predominantly composed of monomers, and the 10 μM samples primarily dimers.

The PC1 loading effectively distinguishes M^{pro} solutions based on their concentrations, with positive values indicating higher concentrations and negative values lower concentrations. A noticeable trend emerges as the concentration of M^{pro} increases, particularly evident in the shift of the phenylalanine peak around 1005 cm⁻¹ towards a lower value of 1000 cm⁻¹. This Raman shift suggests the presence of tensile strain within the system, signifying elongation under applied forces. A simulation study comparing the strain rates between monomeric Tau and dimerized Tau have revealed that dimers exhibit a strain rate approximately seven times higher than monomers. Additionally, the intensity of the phenylalanine peak slightly increases for dimers, a change sensitive to the hydrophobicity of the local environment. X-ray crystallography studies have demonstrated that M^{pro} dimers form through an extensive network of hydrogen bonding and hydrophobic interactions, and with each M^{pro} monomer containing 17 phenylalanine residues, some of which are situated proximately to the regions where the monomers bind to form natural dimers, this further corroborates the increase in phenylalanine peak intensity.

### TRIP: Multiple Linear Regression (MLR)

Subsequently, multiple linear regression (MLR) was employed on the average Raman spectra obtained from three concentrations of M^{pro} samples using the TRIP technique.

MLR is a statistical technique employed to examine the correlation between one dependent variable and two or more independent variables. Unlike simple linear regression, which analyzes the relationship between a single independent variable and a dependent variable, multiple linear regression integrates multiple predictors. The primary aim of multiple linear regression is to construct a linear model that accurately forecasts the values of the dependent variable by considering the values of the independent variables. In this case, the average Raman spectrum of M^{pro} sample is the dependent variable and the Raman spectra of amino acids and known proteins are the independent variables. The same process as before by partitioning the Raman spectral regions into two segments: one spanning from 500 to 1627 cm⁻¹ for amino acid estimation, and another from 1627 to 1700 cm⁻¹ for secondary structure estimation was used. For the estimation of amino acids, the independent variables were 6 specific amino acids—glycine, isoleucine, lysine, methionine, phenylalanine and proline—alongside 4 proteins—SARS CoV 2 receptive binding domain (RBD), lysozyme, insulin, and streptavidin and these same four proteins used as independent variables for the secondary structure fitting.

Most Raman studies consider three common secondary structures such as B sheets, α-helices and others (disordered) for proteins. However, using secondary structures from the dictionary of protein secondary structure (DSSP) analysis, the common classification for the protein structural studies, which assigns secondary structure based on hydrogen bonding patterns, the types of secondary structure were extended up to eight. This included forms such as β sheet, α-helix, residue in β-bridge, 310-helix, π-helix, coils (CCcoilTT), bends, and H-bonded turns. DSSP defines an α-helix as 4 turn helix that has minimum of 4 residues whereas, a β-sheet is defined as an extended strand in parallel and/or anti-parallel that contains minimum length of 2 residues. The 310-helix is defined as a 3 turn helix that has minimum length of 3 residues and the pi-helix as a 5 turn helix that has minimum lengths of 5 residues. The residues in a β-bridge are defined as the residues isolated β-bridges and that single pair of β-sheet hydrogen bond formation. Highly curved parts of a protein are defined as bends that fall under a non-hydrogen bond-based assignment. H-bonded turns are hydrogen bonded turns that could have 3, 4, or 5 turns, and coils are the residues which are not in any of the above seven structures.

In a previous example, the accuracy of estimating the amino acid compositions and secondary structures of the monomer (1 μM) of M^{pro} solution was reported with the root mean square errors (RMSE) of 1.47% and 3.86%, respectively. FIG. 16D shows the results of the MLR including the estimated amino acid compositions and secondary structures of the monomer and natural dimer samples. According to FIG. 16D, the overall trends of a majority of the amino acids were consistent with the concentrations of M^{pro} samples. As the Raman signal is linearly dependent on the concentration of the sample, an increase in the concentrations of M^{pro} samples corresponded to an increase in the Raman signal. However, notable decreases were observed in alanine, glycine, and threonine. These amino acids are considered silent with minimal Raman signal compared to an aromatic amino acid. Furthermore, the histograms in FIG. 16D indicate significant differences in secondary structures between monomer and dimer samples. Particularly, β-sheet content signal was reduced, while α-helical content signal increased in the dimer samples. This anticorrelation between β-sheet and α-helix is consistent with earlier findings from circular dichroism (CD) and small-angle X-ray scattering (SAXS) studies of M^{pro} dimer solutions, reinforcing the reliability of the TRIP results. In terms of coils, the dimer and monomer mix (5 μM M^{pro}) showed a substantial increase, while the dimer sample (10 μM M^{pro}) remained unchanged. Both samples exhibited a slight increase in 310-helical content, whereas the dimer sample showed a notable increase in H-turns.

### Example 13

### Screening of Irreversible Protease Inhibitors: Ligand Assisted Dimers

Synthesizing small inhibitors has become rapid and straightforward. Nevertheless, the subsequent assessment process proves to be both time-consuming and costly, with the majority of prospects ultimately falling short of consideration. To alleviate this challenge, the TRIP technique presents a time and cost savings due to its label-free and non-destructive nature.

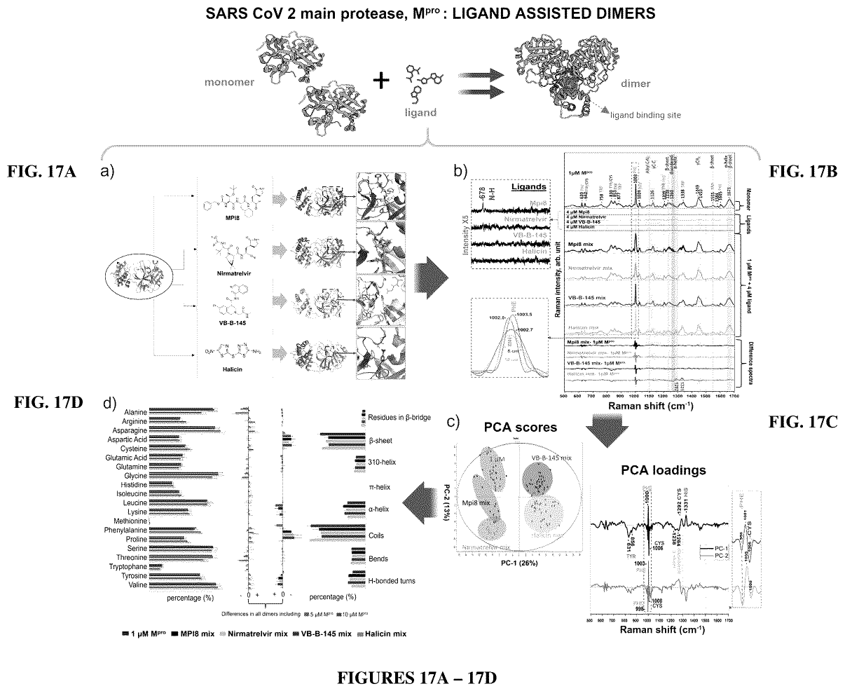

In this example, the TRIP technique was tested to detect binding between monomeric M^{pro} and four known inhibitors, MPI8, Nirmatrelvir, VB-B-145, and Halicin. Their chemical structures and binding sites with M^{pro} are shown in FIG. 17A.

As described previously, the binding sites of all four ligands, except VB-B-145, have been investigated. The binding of VB-B-145 to monomer M^{pro} was simulated using the Schrodinger Desmond MD simulation program. According to FIG. 17D, all four ligands bind to similar region of M^{pro}. However, the three ligands, excluding VB-B-145, exhibit covalent bonding with Cys145 of M^{pro}, and their inhibitory effects were investigated; however, VB-B-145 binds with Cys145 of M^{pro} non-covalently.

### TRIP: Principal Component Analysis (PCA)

The Raman spectra for three different sets of samples were investigated under TRIP conditions. This included the Raman spectra of the 1 μM M^{pro} solution, a set of 4 μM inhibitor solutions, and a set of premixed solutions where 1 μM M^{pro} was combined with 4 μM of the inhibitor and allowed to incubate for 24 hours at 4° C. FIG. 17B visually presents the Raman spectra for these experimental solutions. The Raman spectra of the inhibitors exhibited a nearly flat profile, indicating that any alterations in the Raman spectra of the mixtures were attributable to the binding interaction between the monomer M^{pro} and the inhibitors. As illustrated in FIG. 17B, is the difference spectra derived from the Raman spectra of the mixtures and the Raman spectra of monomer M^{pro} (1 μM) solutions. The Raman spectra of all samples around phenylalanine's 1003 cm⁻¹ are zoomed in FIG. 17B. This peak is downshifted and has substantially decreased intensities for all mixes, whereas the intensity is slightly increased in the natural dimers (FIG. 17B). Surprisingly, the bandwidth of this peak broadened from 6 cm⁻¹ to 12 cm⁻¹ is doubled for the MPI8 and Nirmatrelvir mixes compared to the monomer. Indicating the binding of these ligands to the monomer damped main chain fluctuations resulting in reduced flexibility. According to the difference spectra in FIG. 17B, all mixes had similar trends at phenylalanine's 1003 cm⁻¹ peak, same as the natural dimers in FIG. 16B.

PCA analysis was also employed for the Raman spectra across the whole spectral range (500-1700 cm⁻¹), as depicted in FIG. 17C. The PCA plot effectively separated the monomer (1 μM) and four mixtures, demonstrating the reproducibility of their Raman spectra clustering. The distinct separation in the PCA plots indicated binding interactions between each inhibitor and the monomer M^{pro}, and the combination of PC1 and PC2 loadings effectively distinguish the mixes and monomer samples well. Since, the monomer cluster is located at the quadrant of negative PC1 and positive PC2 loadings, the common peaks in both the loadings represent this sample. The phenylalanine peak at 1005 cm⁻¹ was the common peak for both loadings. Therefore, this peak represents the monomer sample. The clusters of the MPI8 and Nirmatrelvir mixes were in the negative PC1 loading, which had the strongest peak at 1006 cm⁻¹, assigned to cysteine's C—C stretching mode. This peak merged likely due to the covalent bonding of these ligands to Cys145 of the M^{pro} monomer. The next peak was phenylalanine's signature at 998 cm⁻¹ and it was shifted down, similar to the shift previously observed in natural dimers of M^{pro} (FIG. 16C). Another surprise was two peaks around 830 and 858 cm⁻¹ that correspond to the Fermi coupling mode of tyrosine. Any change in the intensity ratio between these two peaks are sensitive to its hydrogen bond. X-ray crystallography studies showed MPI8 and Nirmatrelvir both interact with the same 7 residues of M^{pro} such as Gln189, Glu166, His41, His163, His 164, and including hydrogen bonding with Tyr 140. Clarifying the fact that Nirmatrelvir mix is also located in the negative PC2 quadrant, but the above-mentioned peaks were observed in the negative PC2 loadings too.

The Halicin mixture identified both positive PC1 and negative PC2 loadings. To compare these loadings, the phenylalanine peak at 1000 cm⁻¹ was notably shifted downward from the monomer's value. Particularly intriguing was the emergence of two new peaks at 1292 and 1331 cm⁻¹, corresponding to CH deformation of cysteine and imidazole ring breathing of histidine, respectively. These shifts are attributed to Halicin's covalent binding with Cys145 and a robust van der Waals interaction with His41 of the M^{pro} monomer. The closest distance between Halicin's (nitrothiazole) thiazole ring and the imidazole ring of His41 was measured at 3.4 Å, prompting a 900 flip in the side chain of His41 to accommodate Halicin within the binding pocket. Notably, the byproduct of 5-amino-1,3,4-thiadiazole-2-thiol exhibits Raman peaks around 1290 and 1330 cm⁻¹, albeit with intensities 8-10 times lower than those of stronger Raman peaks associated with this free molecule. However, the difference spectra did not show any of these stronger peaks, casting doubt on this molecule's contribution to these peaks. In summary, while Halicin did not engage in extensive interactions with other amino acids as MPI8 and Nirmatrelvir did, it did interact with Cys145 and His41 of M^{pro}.

VB-B145 mix was located in both positive PC1 and PC2 quadrants with a common peak of these loadings phenylalanine's 1000 cm⁻¹ peak. This absence of any other change in Raman spectra of VB-B-145 was with the understanding that it does not form any covalent bond with M^{pro}. Indeed, in a simulation of VB-B-145 and M^{pro} showed that VB-B-145 indirectly bonded with Cys145 through a free water molecule.

Overall, the PCA results suggested that the dimerization of M^{pro} creates a tensile strain and hydrophobicity change by the down shifting and changing intensities of the phenylalanine peak. These consistent Raman spectral changes were observed in both natural M^{pro} dimers and all four ligand-assisted M^{pro} dimers, supporting their direct association with M^{pro} dimerization.

Another intriguing part lies in the distinct spectral changes observed in the mixes of MPI8, Nirmatrelvir and Halicin. A novel cysteine 1006 cm⁻¹ peak emerges for the MPI8 and Nirmatrelvir mixes, whereas two new cysteine and histidine peaks manifested for the Halicin mix. These findings suggest that the covalent bonding between Cys145 and MPI8 mirrors that of Nirmatrelvir, but differs from the covalent bonding exhibited by Halicin.

### TRIP: Multiple Linear Regression (MLR)

FIG. 17D shows the results of the MRL fittings as histograms of estimated percentages of amino acids and secondary structures for the monomer and ligand-assisted dimers. According to FIG. 17D, the amino acid compositions stayed same (within error) in the MPI8 and Nirmatrelvir mixes comparing monomers, whereas, VB-B-145 and Halicin mixes showed similar changes as the natural dimers (see the differences in all amino acids). For the secondary structures, the Halicin mix had minimal changes, but other mixes showed changes consistent with the natural dimers.

Again, the result of an anticorrelation between α-helices and beta-sheets in all dimer solutions except Halicin assisted dimers was notable. This anticorrelation was previously observed in the M^{pro} protease dimerization study using CD and SAXS. For the Halicin dimer, its β-sheet decreased slightly but its 310-helix increased instead of its α-helix as other dimers. MPI8, Nirmatrelvir and VB-B-145 mixes had slight increases in the H-bonded turns and substantial decreases in the coils.

### Example 14

### Binding Kinetics: Binding Strength/Affinity

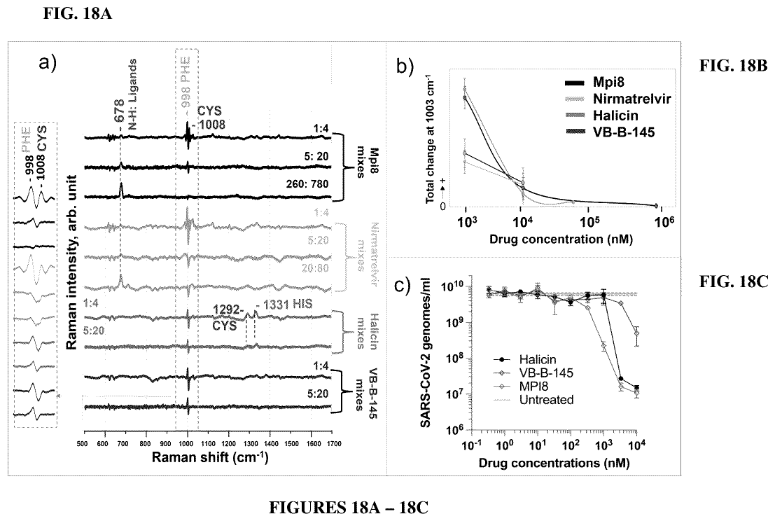

The concentration dependency of the binding between three inhibitors and M^{pro} was investigated using TRIP. Here, the M^{pro} concentrations of 1 μM, 5 μM, and 260 μM were examined for MPI8, while for Halicin and VB-B-145, M^{pro} concentrations of 1 μM and 5 μM were used. The difference Raman spectra of these mixes, revealed subtle variations, corresponding to different concentrations, as presented in FIG. 18A.

This systematic exploration sheds light on how binding characteristics evolve with varying concentrations of M^{pro} and the inhibitors, providing an understanding of their interactions with monomer and dimer M^{pro}. The trends in the difference Raman spectra reveal additional insights. Significantly, there is a reduction in the peak ˜998 cm⁻¹ for phenylalanine, indicating both a downward shift and a decrease in intensity at higher concentrations of M^{pro} mixes across all three inhibitors (FIG. 18A). This suggests a significant reduction in M^{pro} dimerization at higher concentrations.

In the case of MPI8 at higher concentrations, a distinct Raman peak at 678 cm⁻¹ is observed. This indicates that the excess amount of MPI8 doesn't bind M^{pro}, leading to this characteristic peak. It is an indication of the saturation or limited binding capacity at higher MPI8 concentrations.

For the two Halicin mixes, the intensities of cysteine's 1292 cm⁻¹ and 1331 cm⁻¹ peaks increase for the monomer M^{pro} mix compared to the dimer-monomer M^{pro} mix. Halicin's interaction with CYS145 and HIS41 were intensified with monomer M^{pro} sample. This observation implies that Halicin has a higher affinity for binding monomeric M^{pro} as opposed to dimeric M^{pro}.

Finally, when comparing the two VB-B-145 mixes, there is a noticeable decrease in intensity of the phenylalanine 1000 cm⁻¹ peak in the dimer-monomer M^{pro} mix compared to the monomer M^{pro} mix. This suggests that VB-B-145 exhibits a higher affinity for binding with monomer M^{pro} compared to the dimer-monomer mix of M^{pro}.

From these findings, the correlation between the total change in the phenylalanine peak and the concentrations of ligands is illustrated in FIG. 18B. The total alteration of this peak is calculated by multiplying the degree of peak shift by the magnitude of intensity change observed in the mixes. This graph serves as a representation of the binding strength or affinity of these ligands, as determined by TRIP.

Meanwhile, the antiviral effectiveness's of MPI8, VB-B-145 and Halicin were tested in A549-Ace2 cells using an early Delta variant of SARS-CoV-2 as shown in FIG. 18C. The negative controls were infected but not treated. Results showing inhibition of virus growth, as measured by reverse transcriptase quantitative PCR are shown, based on three replicates per condition.

There is notable agreement between the antiviral effectiveness depicted in FIG. 18C and the binding strength illustrated in FIG. 18B for these ligands. Specifically, MPI8 exhibited substantially higher efficiency in binding and dimerizing the protease compared to the other two ligands. Halicin and VB-B-145 demonstrated similar binding affinity, with exceptions noted at the highest concentration in FIG. 18C.

1. A method of evaluating an interaction between a first composition and a second composition, the method comprising the step of subjecting the interaction between the first composition and the second composition to Raman spectroscopy, wherein the step of subjecting is performed at a temperature between about 0° C. and about 40° C.

2. The method of claim 1, wherein the first composition is comprised in an aqueous composition, wherein the aqueous composition is a solution.

3. The method of claim 2, wherein the aqueous composition is present at near physiological conditions.

4. The method of claim 1, wherein the second composition is comprised in an aqueous composition, wherein the aqueous composition is a solution.

5. The method of claim 4, wherein the aqueous composition is present at near physiological conditions.

6. The method of claim 1, wherein the first composition is a drug and wherein the second composition is a drug target.

7. The method of claim 1, wherein the first composition is an antibody and wherein the second composition is an antigen.

8. The method of claim 1, wherein the method is configured for evaluating the interaction in less than 1 minute.

9. The method of claim 8, wherein the method does not substantially degrade the first composition or the second composition, wherein the degrading is heat-derived degradation.

10. The method of claim 1, wherein the step of subjecting is performed at a temperature between about 0° C. and about 5° C.

11. A method of evaluating an interaction between a first biomolecule and a second biomolecule, the method comprising the step of subjecting the interaction between the first biomolecule and the second biomolecule to Raman spectroscopy, wherein the step of subjecting is performed at a temperature between about 0° C. and about 40° C.

12. The method of claim 11, wherein the first biomolecule is selected from the group consisting of a protein, a peptide, an amino acid, a nucleic acid, a synthetic analog of a nucleic acid, a sugar, a carbohydrate, and a lipid, and wherein the second biomolecule is selected from the group consisting of a protein, a peptide, an amino acid, a nucleic acid, a synthetic analog of a nucleic acid, a sugar, a carbohydrate, and a lipid.

13. The method of claim 11, wherein the first biomolecule is comprised in an aqueous composition, wherein the aqueous composition is a solution.

14. The method of claim 13, wherein the aqueous composition is present at near physiological conditions.

15. The method of claim 11, wherein the second biomolecule is comprised in an aqueous composition, wherein the aqueous composition is a solution.

16. The method of claim 11, wherein the aqueous composition is present at near physiological conditions.

17. The method of claim 11, wherein the method is configured for evaluating the interaction in less than 1 minute.

18. The method of claim 17, wherein the method does not substantially degrade the first composition or the second composition, wherein the degrading is heat-derived degradation.

19. The method of claim 11, wherein the step of subjecting is performed at a temperature between about 0° C. and about 5° C.

20. The method of claim 11, wherein the step of subjecting is performed at a temperature below 10° C.
